(19) United States
(12) Patent Application Publication
(10) Pub. No.: US 2013/0037479 A1
(43) Pub. Date: Feb. 14, 2013

(54) HOLLOW FIBER FORWARD OSMOSIS MEMBRANE

(71) Applicants: Hidechito Hayashi, Nagasaki-shi (JP); Tetsuya Okumura, Nagasaki-shi (JP); Hideyuki Sakai, Nagasaki-shi (JP); Morihiro Irie, Nisisonogi-gun (JP)

(72) Inventors: Hidechito Hayashi, Nagasaki-shi (JP); Tetsuya Okumura, Nagasaki-shi (JP); Hideyuki Sakai, Nagasaki-shi (JP); Morihiro Irie, Nisisonogi-gun (JP)

(73) Assignee: KYOWAKIDEN INDUSTRY CO., LTD, Nagasaki (JP)

(21) Appl. No.: 13/642,948

(22) PCT Filed: Jun. 24, 2011
(86) PCT No.: PCT/JP2011/064502

§ 371 Date: Oct. 23, 2012

(30) Foreign Application Priority Data
Jun. 28, 2010 (JP) 2010-146956

(51) Int. Cl. B01D 63/02

(52) U.S. Cl. 210/321.66

(57) ABSTRACT

It is an object of the present invention to provide a hollow fiber forward osmosis membrane, which can enhance forward osmotic pressure energy acquired by permeation, and thus improve power generation efficiency in the forward osmotic pressure power generation, when dilution water such as freshwater permeates into seawater through the osmosis membrane. The relationship between optimal conditions for an inner diameter d and a length L of the hollow fiber osmosis membrane to be used for forward osmotic pressure power generation whereby dilution water such as fresh water is caused to permeate into non-concentrate seawater through the hollow fiber osmosis membrane to increase a flow rate on the side of the seawater using forward osmotic pressure energy thus generated, and power is generated using the increased flow rate, is expressed as equation (1) in the range of d=50 to 200 μm, L=0.5 to 2 m and J=1.7×10⁻⁷ to 5.1×10⁻⁷ m/sec,

[Equation 11]

$$\frac{d}{{L}^{0.75} + {J}^{0.5}} = 1.0 \times {10}^{5} ∼ 1.2 \times {10}^{5}$$

wherein
J means permeation flux rate.

### TECHNICAL FIELD

The present invention relates to a hollow fiber forward osmosis membrane used for forward osmotic pressure power generation that employs, for example, forward osmotic pressure energy of concentrate seawater generated at the same time when seawater is desalinated by a seawater desalination plant using reverse osmotic pressure, or forward osmotic pressure energy of non-concentrate seawater in the ocean or in the natural world.

### BACKGROUND ART

For example, there is known forward osmotic pressure power generation whereby concentrate seawater, which has been generated at the same time when seawater is desalinated by a seawater desalination plant using reverse osmotic pressure, is caused to be permeated through an osmosis membrane with dilution water such as freshwater or seawater having lower saline concentration than the concentrate seawater to increase flow rate on the side of the concentrate seawater by forward osmotic pressure energy thus acquired, and power is generated using the flow rate thus increased.

Also, there is known another forward osmotic pressure power generation for causing dilution water such as freshwater to permeate into non-concentrate seawater in the ocean or in the natural world through, for example, an osmosis membrane, to increase flow rate on the side of the seawater by forward osmotic pressure energy thus acquired, and to generate power using the flow rate thus increased.
Patent Document 1: Japanese Unexamined Patent Application, Publication No. 2003-176775

### DISCLOSURE OF THE INVENTION

### Problems to be Solved by the Invention

However, in forward osmotic pressure power generation, no dedicated membrane has yet been developed as an osmosis membrane to be used to cause the dilution water such as freshwater or seawater having lower saline concentration than concentrate seawater to permeate through into the concentrate seawater. Similarly, no dedicated membrane has yet been developed as an osmosis membrane to be used to cause the dilution water such as freshwater to permeate through into the non-concentrate seawater in the ocean or in the natural world. Only as an interim solution, a hollow fiber reverse type osmosis membrane for use in seawater desalination has been employed. As a result thereof, contrary to initial expectations, the acquired forward osmotic pressure energy has been insufficient and the power generation efficiency has been far from satisfactory.

The present invention has been conceived in view of the above-stated drawbacks, and it is an object of the present invention to provide a hollow fiber forward osmosis membrane, which can enhance forward osmotic pressure energy acquired by permeation, and thus improve power generation efficiency in the forward osmotic pressure power generation, when dilution water such as freshwater or seawater lower in saline concentration than concentrate seawater permeates into the concentrate seawater through the osmosis membrane, or dilution water such as freshwater permeates into non-concentrate seawater in the ocean or in the natural world through the osmosis membrane.

### Means for Solving the Problems

In order to overcome the above-mentioned drawbacks, in accordance with a first aspect of the present invention, there is provided a hollow fiber forward osmosis membrane, wherein a relationship between optimal conditions for an inner diameter d and a length L of the hollow fiber osmosis membrane for use in forward osmotic pressure power generation which causes dilution water such as freshwater or seawater having a less saline concentration than concentrate seawater to permeate into the concentrate seawater through the hollow fiber osmosis membrane and to increase a flow rate on the side of the concentrate seawater using forward osmotic pressure energy thus generated, and generates power using the increased flow rate, is expressed as the following [Equation 1] in the range of d=50 to 200 μm, L=0.5 to 2 m, and J=3.42×10⁻⁷ to 6.84×10⁻⁷ m/sec,

### [Equation 1]

$$\frac{d}{{L}^{0.75} + {J}^{0.5}} = 1.9 \times {10}^{5} ∼ 2.2 \times {10}^{5}$$

wherein J means permeation flux rate.

Furthermore, in order to overcome the above-mentioned drawbacks, in accordance with a second aspect of the present invention, there is provided a hollow fiber forward osmosis membrane, wherein the relationship between optimal conditions for an inner diameter d and a length L of the hollow fiber osmosis membrane for use in forward osmotic pressure power generation which causes a dilution water such as freshwater to permeate into non-concentrate seawater through the hollow fiber osmosis membrane, and to increase a flow rate on the side of the seawater using forward osmotic pressure energy thus generated, and generates power using the increased flow rate, is expressed as the following [Equation 11] in the range of d=50 to 200 μm, L=0.5 to 2 m, and J=1.7×10⁻⁷ to 5.1×10⁻⁷ m/sec

### [Equation 11]

$$\frac{d}{{L}^{0.75} + {J}^{0.5}} = 1.0 \times {10}^{5} ∼ 1.2 \times {10}^{5}$$

wherein J means permeation flux rate.

### Effects of the Invention

In order to solve the aforementioned drawbacks, the hollow fiber forward osmosis membrane according to the first aspect of the present invention causes dilution water such as freshwater or seawater having a less saline concentration than concentrate seawater to permeate therethrough into the concentrate seawater, thereby increasing forward osmotic pressure energy, which increases a flow rate on the side of the seawater, and the increased flow can improve the power generation efficiency. Consequently, the hollow fiber forward osmosis membrane according to the first aspect of the present invention can provide a remarkably novel and beneficial effect of making it possible for the net energy calculated by subtracting the consumption energy consumed by the power generation from the output energy acquired by the power generation to be several times greater than the consumption energy.

Furthermore, in order to solve the aforementioned drawbacks, the hollow fiber forward osmosis membrane according to the second aspect of the present invention causes dilution water such as freshwater to permeate therethrough into non-concentrate seawater in the ocean or in the natural world, thereby increasing forward osmotic pressure energy, which increases a flow rate on the side of the seawater, and the increased flow rate can improve the power generation efficiency. Consequently, the hollow fiber forward osmosis membrane according to the second aspect of the present invention can provide a remarkably novel and beneficial effect of making it possible for the net energy calculated by subtracting the consumption energy consumed by the power generation from the output energy acquired by the power generation to be several times greater than the consumption energy.

### BRIEF DESCRIPTION OF THE DRAWINGS

FIG. 1 is an explanatory drawing of a thick walled cylinder on which internal and external pressures are acting, according to a first embodiment of the present invention;

FIG. 2 is an explanatory drawing showing a method of tensile testing, according to the first embodiment of the present invention;

FIG. 3 is a graph showing a relationship between elastic deformation and weight, according to the first embodiment of the present invention;

FIG. 4 is a graph showing a relationship between outer and inner diameters, according to the first embodiment of the present invention;

FIG. 5 is an overall system diagram of forward osmotic pressure power generation according to the first embodiment of the present invention;

FIG. 6 is a graph showing permeation flux rate per hollow fiber forward osmosis membrane in relation to changes in length, according to the first embodiment of the present invention, wherein

FIG. 6A shows a case in which water completely permeates before reaching the end of the hollow fiber forward osmosis membrane, and FIG. 6B shows a case in which water permeates through the entire hollow fiber forward osmosis membrane (the permeated water is partially returned);

FIG. 7 is an explanatory drawing of permeation flux rate at an infinitesimal length, according to the first embodiment of the present invention;

FIG. 8 is a graph showing a relationship between an inner diameter and a permeation flux rate per element, according to the first embodiment of the present invention;

FIG. 9 is a partial perspective view showing a bunch of a plurality of hollow fiber forward osmosis membranes 1 tightly inserted into a cylindrical body 2 of 9 or 10 inch inner diameter, according to the first embodiment of the present invention;

FIG. 10 is a graph showing a variation of an overall efficiency ηₐₗₗ in relation to changes of the permeation flux rate J, under the condition that the inner diameter of the cylindrical body 2 is 9 inches and the length of the hollow fiber forward osmosis membrane is 0.5 m, according to the first embodiment of the present invention;

FIG. 11 is a graph showing a variation of the overall efficiency ηₐₗₗ in relation to changes of the permeation flux rate J, under the condition that the inner diameter of the cylindrical body 2 is 9 inches and the length of the hollow fiber forward osmosis membrane is 1 m, according to the first embodiment of the present invention;

FIG. 12 is a graph showing a variation of the overall efficiency ηₐₗₗ in relation to changes of the permeation flux rate J, under the condition that the inner diameter of the cylindrical body 2 is 9 inches and the length of the hollow fiber forward osmosis membrane is 1.5 m, according to the first embodiment of the present invention;

FIG. 13 is a graph showing a variation of the overall efficiency ηₐₗₗ in relation to changes of the permeation flux rate J, under the condition that the inner diameter of the cylindrical body 2 is 9 inches and the length of the hollow fiber forward osmosis membrane is 2 m, according to the first embodiment of the present invention;

FIG. 14 is a graph showing a variation of the overall efficiency ηₐₗₗ in relation to changes of the permeation flux rate J, under the condition that the inner diameter of the cylindrical body 2 is 10 inches and the length of the hollow fiber forward osmosis membrane is 0.5 m, according to the first embodiment of the present invention;

FIG. 15 is a graph showing a variation of the overall efficiency ηₐₗₗ in relation to changes of the permeation flux rate J, under the condition that the inner diameter of the cylindrical body 2 is 10 inches and the length of the hollow fiber forward osmosis membrane is 1 m, according to the first embodiment of the present invention;

FIG. 16 is a graph showing a variation of the overall efficiency ηₐₗₗ in relation to changes of the permeation flux rate J, under the condition that the inner diameter of the cylindrical body 2 is 10 inches and the length of the hollow fiber forward osmosis membrane is 1.5 m, according to the first embodiment of the present invention;

FIG. 17 is a graph showing a variation of the overall efficiency ηₐₗₗ in relation to changes of the permeation flux rate J, under the condition that the inner diameter of the cylindrical body 2 is 10 inches and the length of the hollow fiber forward osmosis membrane is 2 m, according to the first embodiment of the present invention;

FIG. 18 is a graph showing a fact that an optimal condition parameter falls within the range shown by [Equation 1] when the length of the hollow fiber forward osmosis membrane is within the conditional range according to the first embodiment of the present invention;

FIG. 19 is an explanatory drawing of a thick walled cylinder on which internal and external pressures are acting, according to a second embodiment of the present invention;

FIG. 20 is an explanatory drawing showing a method of tensile testing according to the second embodiment of the present invention;

FIG. 21 is a graph showing a relationship between elastic deformation and weight, according to the second embodiment of the present invention;

FIG. 22 is a graph showing a relationship between outer and inner diameters, according to the second embodiment of the present invention;

FIG. 23 is an overall system diagram of forward osmotic pressure power generation according to the second embodiment of the present invention;

FIG. 24 is a graph showing permeation flux rate per hollow fiber forward osmosis membrane in relation to changes in length, according to the second embodiment of the present invention, wherein FIG. 24A shows a case in which water completely permeates before reaching the end of the hollow fiber forward osmosis membrane, and FIG. 24B shows a case in which water permeates through the entire hollow fiber forward osmosis membrane (permeated water is partially returned);

FIG. 25 is an explanatory drawing of permeation flux rate at an infinitesimal length, according to the second embodiment of the present invention;

FIG. 26 is a graph showing a relationship between an inner diameter and permeation flux rate per element, according to the second embodiment of the present invention;

FIG. 27 is a partial perspective view when a bunch of a plurality of hollow fiber forward osmosis membranes 1 tightly inserted into a cylindrical body 2 of 9 or 10 inch inner diameter, according to the second embodiment of the present invention;

FIG. 28 is a graph showing a variation of an overall efficiency ηₐₗₗ in relation to changes of the permeation flux rate J, under the condition that the inner diameter of the cylindrical body 2 is 9 inches and the length of the hollow fiber forward osmosis membrane is 0.5 m, according to the second embodiment of the present invention;

FIG. 29 is a graph showing a variation of the overall efficiency ηₐₗₗ in relation to changes of the permeation flux rate J, under the condition that the inner diameter of the cylindrical body 2 is 9 inches and the length of the hollow fiber forward osmosis membrane is 1 m, according to the second embodiment of the present invention;

FIG. 30 is a graph showing a variation of the overall efficiency ηₐₗₗ in relation to changes of the permeation flux rate J, under the condition that the inner diameter of the cylindrical body 2 is 9 inches and the length of the hollow fiber forward osmosis membrane is 1.5 m, according to the second embodiment of the present invention;

FIG. 31 is a graph showing a variation of the overall efficiency ηₐₗₗ in relation to changes of the permeation flux rate J, under the condition that the inner diameter of the cylindrical body 2 is 9 inches and the length of the hollow fiber forward osmosis membrane is 2 m, according to the second embodiment of the present invention;

FIG. 32 is a graph showing a variation of the overall efficiency ηₐₗₗ in relation to changes of the permeation flux rate J, under the condition that the inner diameter of the cylindrical body 2 is 10 inches and the length of the hollow fiber forward osmosis membrane is 0.5 m, according to the second embodiment of the present invention;

FIG. 33 is a graph showing a variation of the overall efficiency ηₐₗₗ in relation to changes of the permeation flux rate J, under the condition that the inner diameter of the cylindrical body 2 is 10 inches and the length of the hollow fiber forward osmosis membrane is 1 m, according to the second embodiment of the present invention;

FIG. 34 is a graph showing a variation of the overall efficiency ηₐₗₗ in relation to changes of the permeation flux rate J, under the condition that the inner diameter of the cylindrical body 2 is 10 inches and the length of the hollow fiber forward osmosis membrane is 1.5 m, according to the second embodiment of the present invention;

FIG. 35 is a graph showing a variation of the overall efficiency ηₐₗₗ in relation to changes of the permeation flux rate J, under the condition that the inner diameter of the cylindrical body 2 is 10 inches and the length of the hollow fiber forward osmosis membrane is 2 m, according to the second embodiment of the present invention; and

FIG. 36 is a graph showing a fact that an optimal condition parameter falls within the range shown by [Equation 11] when the length of the hollow fiber forward osmosis membrane is within the conditional range according to the second embodiment of the present invention.

### EXPLANATION OF REFERENCE NUMERALS

1 hollow fiber forward osmosis membrane
2 cylindrical body

### BEST MODE FOR CARRYING OUT THE INVENTION

### First Embodiment

The description hereinafter is directed to how the relationship of optimal conditions for a hollow fiber forward osmosis membrane according to the present invention has been acquired.

In view of forward osmotic pressure power generation using a hollow fiber forward osmosis membrane, the presently employed hollow fiber type reverse osmosis membrane is insufficient to achieve an optimal situation. The inventor of the present invention has found optimal membrane conditions for forward osmotic pressure power generation by conducting following evaluations.

### (1) Optimal Thickness in Relation to Inner Diameter of Hollow Fiber Forward Osmosis Membrane

The hollow fiber osmosis membrane for reverse osmosis is used at a pressure of 8 MPa, while, on the other hand, the hollow fiber osmosis membrane for forward osmosis power generation is used at a pressure of 3 MPa, which is less than half of the pressure in the case of the reverse osmosis. Accordingly, it appears possible to reduce the thickness of the hollow fiber forward osmosis membrane. The inventor of the present invention thought that great effect could be expected if the thickness of the membrane were reduced since concentration polarization within the membrane could be suppressed.

### (2) Calculation of System Efficiency

As described in the above, in order to acquire optimal parameters for forward osmotic pressure power generation, it is required to calculate the system efficiency. By calculating the system efficiency, it becomes possible to practically evaluate the forward osmotic pressure power generation.

### (3) Theoretical Calculation of Variation of Permeation Flux Rate Per Element in Relation to Variation of Inner Diameter of Hollow Fiber Forward Osmosis Membrane

In the case of the hollow fiber type reverse osmosis membrane, freshwater comes into the hollow fiber osmosis membrane as a result of high pressure on the side of saline water. On the other hand, in the case of the forward osmotic pressure power generation, since freshwater flowing in the hollow fiber osmosis membrane permeates on the side of seawater, the freshwater may completely permeate before reaching the end of the hollow fiber osmosis membrane, depending upon the amount of the flowing freshwater. On the other hand, if a sufficient amount of freshwater flows in the hollow fiber osmosis membrane, this results in a heavy loss in the view of power generation efficiency. Accordingly, it is required to find out optimal flowing conditions on the side of freshwater of the hollow fiber osmosis membrane in the forward osmotic pressure power generation.

(4) On the Bases of the Aforementioned Evaluations, Optimal Parameter Conditions have been Acquired for the Hollow Fiber Forward Osmosis Membrane.

### (1) Optimal Thickness in Relation to Inner Diameter of Hollow Fiber Forward Osmosis Membrane

Currently, the hollow fiber osmosis membrane for reverse osmosis is employed. This kind of hollow fiber osmosis membrane is designed to have a thickness sufficient not to break even under a pressure of 8 MPa. On the other hand, in the forward osmotic pressure power generation, experiments so far show that an optimal pressure is 3 MPa, i.e., less than half is sufficient for pressure resistance. The optimal thickness in this case has been calculated as follows.

1) Theoretical calculation of a stress generated in the hollow fiber forward osmosis membrane.
2) Evaluation test of a yield stress of the hollow fiber forward osmosis membrane.
3) Calculation of an optimal thickness for use in the forward osmotic pressure power generation based on safety factor.

### 1) Theoretical Calculation of Stress Generated in Hollow Fiber Forward Osmosis Membrane

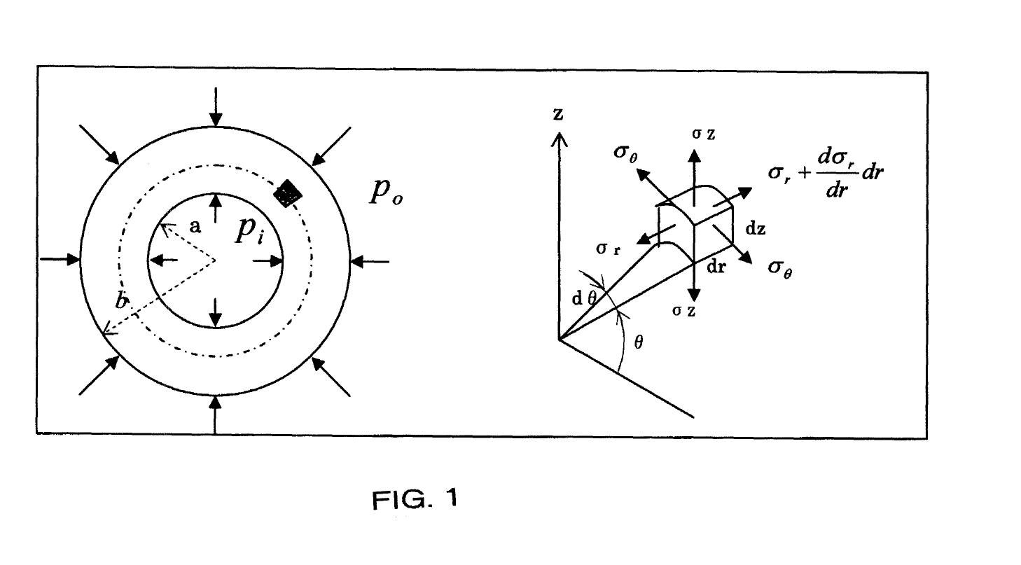

A stress in a circumferential direction generated by internal and external pressures exerted on the hollow fiber forward osmosis membrane shown in FIG. 1 can be expressed by the following [Equation 2].

### [Equation 2]

$${σ}_{r} = \frac{1}{{b}^{2} - {a}^{2}} \{ {P}_{i} \cdot {a}^{2} ( 1 - \frac{{b}^{2}}{{r}^{2}} ) - {P}_{o} \cdot {b}^{2} ( 1 - \frac{{a}^{2}}{{r}^{2}} ) \} \\ {σ}_{θ} = \frac{1}{{b}^{2} - {a}^{2}} \{ {P}_{i} \cdot {a}^{2} ( 1 + \frac{{b}^{2}}{{r}^{2}} ) - {P}_{o} \cdot {b}^{2} ( 1 + \frac{{a}^{2}}{{r}^{2}} ) \} \\ {σ}_{z} = 2 υ \frac{{P}_{i} \cdot {a}^{2} - {P}_{o} \cdot {b}^{2}}{{b}^{2} - {a}^{2}} + E {ɛ}_{z} = υ ( {σ}_{r} + {σ}_{z} ) + E {ɛ}_{z} \qquad ( 1 )$$

wherein Pₒ denotes an external pressure, Pᵢ denotes an internal pressure, a denotes an inner radius, b denotes an outer radius, σᵣ denotes a stress in a radial direction, σ_{θ} denotes a stress in a circumferential direction, and σ_{z} denotes a stress in an axial direction (see Saimoto, A., Hirano, T., Imai, Y. “Material Mechanics” pp. 108-110).

Since both ends of the hollow fiber forward osmosis membrane can be assumed to be open in this case, σ_{z}=0. Furthermore, owing to the condition Pₒ>>Pᵢ, |σᵣ|≦|σ_{θ}|. Accordingly, σ_{θ} is the maximum stress in the hollow fiber forward osmosis membrane.

### 2) Evaluation Test of Yield Stress of Hollow Fiber Forward Osmosis Membrane

In order to prevent plastic deformation against the above described stress, an appropriate thickness is required. Therefore, an experiment has been conducted to calculate a yield point, and the optimal thickness has been considered in view of the yield point.

### Method of Experiment

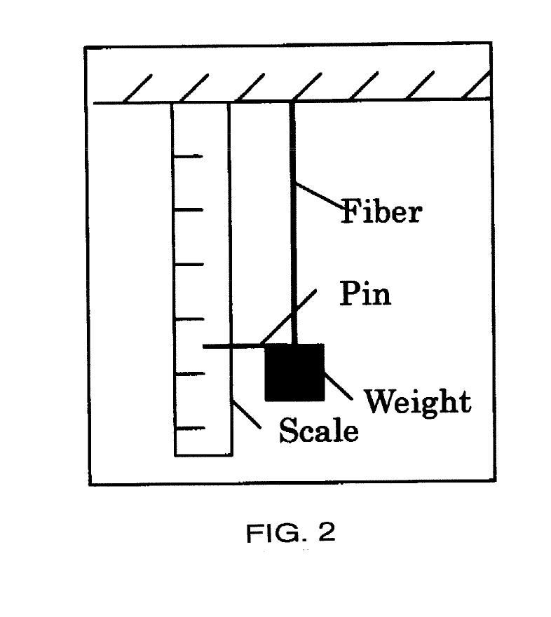

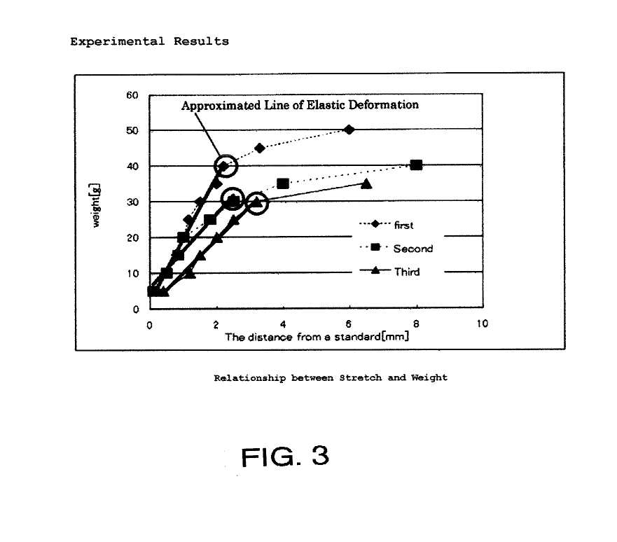

The yield stress has been acquired by conducting a tensile test as shown in FIG. 2. As an original point, a position at which the pin was placed when no weight was hung was marked on the scale. Firstly, a weight of 5 g was hung, and the distance the pin moved from the original point was measured on the scale. Then, the weight was removed, and it was checked whether or not the pin returned to the original point. In this manner, similar measurements were subsequently conducted with weights of 10 g, 15 g, . . . , 40 g, in ascending order of weight so as to ascertain a weight from which the plastic deformation begins to occur. Such experiments were repeated three times. The result of the experiments (relationship between stretch and weight) is shown in a graph of FIG. 3.

It is assumed that the plastic deformation begins to occur at the weight where a slope of the graph remarkably changes. Since, the second and third experiments showed the similar results in FIG. 3, it is determined that the plastic deformation begins at a weight of 30 g. Denoting a cross section area as A and a weight as F, the yield stress is calculated from the following equation [Equation 3]. This indicates that the value is approximately the same as that of nylon.

### [Equation 3]

Yield stress σ_{y} is expressed as follows.

$${σ}_{y} = \frac{F}{A} = \frac{30 \cdot {10}^{- 3} \cdot 9.8}{\frac{π}{4} ( {d}_{o}^{2} - {d}_{i}^{2} )} = 35.7 [ MPa ] \qquad ( 2 )$$

(nylon σ_{y}=40[MPa])

### 3) Calculation of Optimal Thickness for Use in Forward Osmotic Pressure Power Generation Based on Safety Factor

The currently employed hollow fiber forward osmosis membrane is designed to have a thickness sufficient not to break even under a pressure of 8 MPa. A theoretical radius a of the hollow fiber forward osmosis membrane is calculated as follows:

Firstly, as the actual hollow fiber forward osmosis membrane specifications, the values of the outer radius b=55 [μm], the external pressure Po=8 [MPa], and the internal pressure Pi=20[kPa] are assigned to the term of theoretical stress σ_{θ} of the hollow fiber forward osmosis membrane in Equation (1). Then, assuming that the maximum stress position r=a, and using the yield stress σ_{y} calculated as a result of Equation (2), in view of σ_{θ}<σ_{y}, which is a condition for preventing the hollow fiber forward osmosis membrane from breaking, the theoretical radius a is acquired as 40 μm.

Accordingly, a theoretical thickness is acquired as follows.

t′=b−a=55−40=15 [μm].

However, the actual thickness is made thicker than the theoretical thickness in view of safety factor. Using the actual thickness t=35 [μm], the safety factor is acquired as follows.

s=35/15=2.333 . . . =2.5

Since the external pressure applied to the hollow fiber forward osmosis membrane is approximately 3 MPa in an actual environment, using a condition of the external pressure=3 MPa and the safety factor as acquired in the above, a thickness to which the safety factor is applied is estimated.

Equation (1) is calculated in a similar way, by merely changing the external pressure Po=3 Mpa in Equation (1), a theoretical inner radius a=50 [μm] is acquired. As a result of this, thickness t′=55−50=5 [μm] is acquired. In view of the safety factor, the thickness t is acquired as follows (outer radius standard).

t=s·t′=2.5×5=12.5 [μm]

Based on the above results, a relationship between thickness and inner diameter in view of the safety factor is acquired as follows.

t=0.118di+2×10⁻⁶ (3)

The thickness is expressed as follows.

do−di=2t (4)

di is acquired from Equation (3),

di=(do−4×10⁻⁶)/1.236 (5)

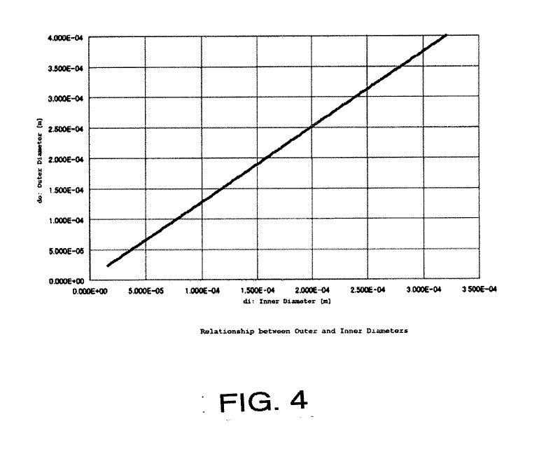

From equation (5), a relationship between outer and inner diameters is acquired, which is shown in FIG. 4.

### (2) Calculation of System Efficiency

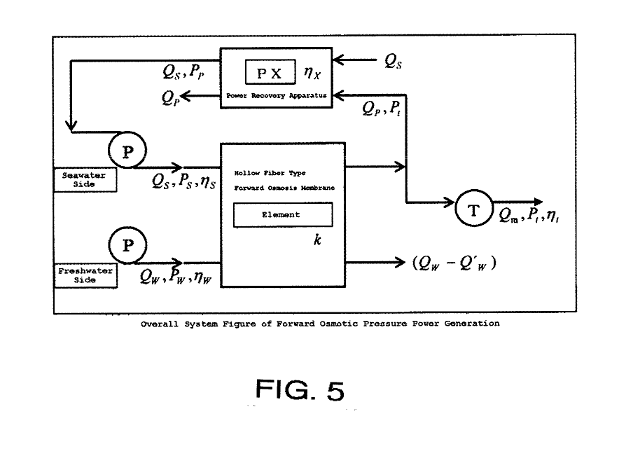

Here, instead of efficiency of a single hollow fiber forward osmosis membrane, efficiency of the entire forward osmotic pressure power generation system shown in FIG. 5 is considered. The explanation of reference numerals in FIG. 5 is shown in [Equation 4]. The calculation of system efficiency is shown in [Equation 5] and [Equation 6]. The power recovery apparatus in [Equation 5] is denoted by “PX” in FIG. 5.

### [Equation 4]

Seawater side pump power: Es
Freshwater side pump power: Ew
Seawater side pump efficiency: ηₛ
Freshwater side pump efficiency: η_{w}
Seawater side pump pressure: Ps
Freshwater side pump pressure: Pw
Seawater side pump compression flow rate: Qs
Freshwater side pump compression flow rate: Qw
Turbine flow rate: Qm
Permeation flux rate: Q′w
Turbine output: Et
Turbine efficiency: ηₜ
Power recovery apparatus efficiency: ηₓ
Power recovery apparatus outlet pressure: Pp

### [Equation 5]

### Output

Eₜ=ηₜ·Pₜ·Qₘ

### Power

$${E}_{s} = \frac{( {P}_{s} - {P}_{p} ) {Q}_{s}}{{η}_{s}}$$

$${E}_{w} = \frac{{P}_{w} \cdot {Q}_{w}}{{η}_{w}}$$

Flow rate

Qₘ=(Qₛ+Q′_{w})−Qₚ

Loss in a unit

Pₜ=kPₛ

The net output calculated from the above equations is expressed as follows.

$$\begin{matrix}{E}_{n} = {E}_{t} - ( {E}_{s} + {E}_{w} ) \\ = {η}_{t} \cdot {P}_{t} \cdot {Q}_{m} - ( \frac{( {P}_{s} - {P}_{p} ) {Q}_{s}}{{η}_{s}} + \frac{{P}_{w} \cdot {Q}_{w}}{{η}_{w}} ) \\ = {η}_{t} \cdot {kP}_{s} ( {Q}_{s} + {Q}_{w}^{′} - {Q}_{p} ) - ( \frac{( {P}_{s} - {P}_{p} ) {Q}_{s}}{{η}_{s}} + \frac{{P}_{w} \cdot {Q}_{w}}{{η}_{w}} )\end{matrix}$$

Since the following conditions are required in the power recovery apparatus,

Qₚ=hQₛ(h≅1),

The following condition is required.

Pₚ=ηₓkPₛ

Accordingly, it follows that

$${E}_{n} = {η}_{t} \cdot {kP}_{s} ( {Q}_{w}^{′} + ( 1 - h ) {Q}_{s} ) - \frac{1 - k {η}_{x}}{{η}_{s}} {P}_{s} {Q}_{s} - \frac{{P}_{w} \cdot {Q}_{w}}{{η}_{w}}$$

### [Equation 6]

Defining a permeating rate x (1>x) as a rate of freshwater permeating into seawater, a flow rate between inlet and outlet on the freshwater side is expressed as follows.

Q′_{w}=Q_{w}·x.

Defining y (1>>y) as a ratio of freshwater side pressure to seawater side pressure, Pw/Ps=y follows.
Defining z (1>z) as a ratio of freshwater side inlet flow rate to seawater side flow rate,

Qw/Qs=z follows.

Using the above definitions,

$$\begin{matrix}{E}_{n} = k {η}_{t} {P}_{s} \{ ( 1 - h ) {Q}_{s} + {xzQ}_{s} \} - ( \frac{1 - k {η}_{x}}{{η}_{s}} {P}_{s} {Q}_{s} + \frac{yz}{{η}_{w}} {P}_{s} {Q}_{s} ) \\ = \{ k {η}_{t} ( 1 - h ) + k {η}_{t} xz - \frac{1 - k {η}_{x}}{{η}_{s}} - \frac{yz}{{η}_{w}} \} {P}_{s} {Q}_{s}\end{matrix}$$

Thus, the overall efficiency is expressed as follows.

$$\begin{matrix}{η}_{all} = \frac{{E}_{n}}{{E}_{s} + {E}_{w}} \\ = \frac{\{ k {η}_{t} ( 1 - h ) + k {η}_{t} xz - \frac{1 - k {η}_{x}}{{η}_{s}} - \frac{yz}{{η}_{w}} \} {P}_{s} {Q}_{s}}{( \frac{1 - k {η}_{x}}{{η}_{s}} + \frac{yz}{{η}_{w}} ) {P}_{s} {Q}_{s}}\end{matrix} \qquad ( 6 )$$

The overall efficiency ηₐₗₗ of Equation (6) is acquired by dividing net energy by consumption energy, wherein the net energy is acquired by subtracting the consumption energy from output energy. The output energy is energy generated by the forward osmotic pressure power generation. The consumption energy is energy consumed for operating the forward osmotic pressure power generation.

### (3) Theoretical Calculation of Variation of Permeation Flux Rate Per Element in Relation to Variation of Hollow Fiber Forward Osmosis Membrane Inner Diameter

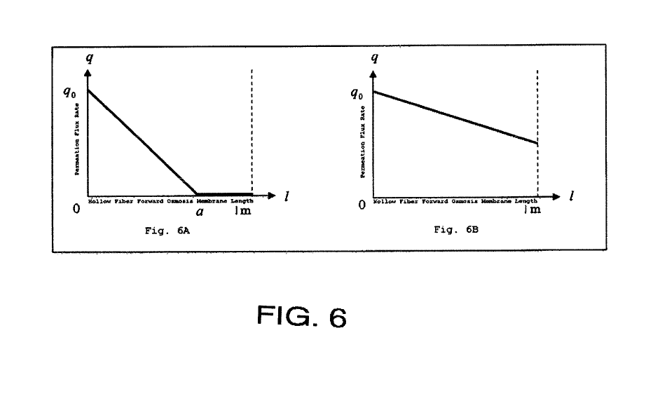

FIG. 6 shows the permeation flux rate per hollow fiber forward osmosis membrane in relation to changes in length. Here, FIG. 6A shows a case in which water completely permeates before reaching the end of the hollow fiber forward osmosis membrane, and FIG. 6B shows a case in which water permeates through the entire hollow fiber forward osmosis membrane (the permeated water is partially returned).

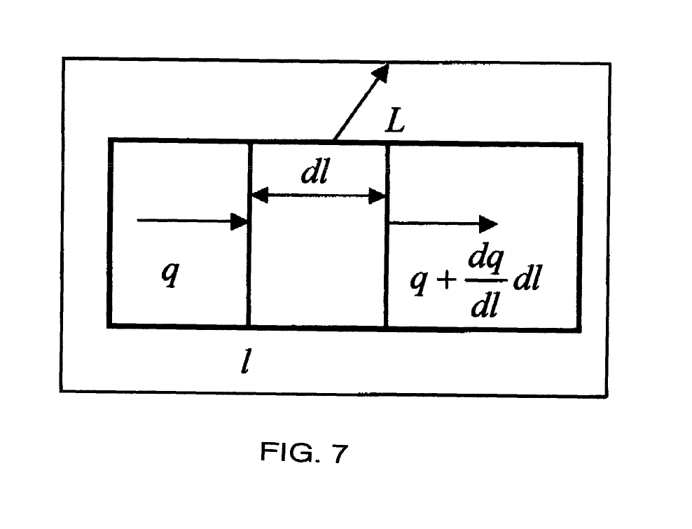

Assuming the length of the hollow fiber forward osmosis membrane to be 1 m, two cases of FIGS. 6A and 6B are considered. As for the case of FIG. 6A, water completely permeates before reaching 1 m. On the other hand, as for the case of FIG. 6B, water permeates through the entire hollow fiber forward osmosis membrane.

[Equation 7] to [Equation 9] show how the case of FIG. 6A in which water completely permeates before reaching the end of the hollow fiber forward osmosis membrane is theoretically calculated with reference to FIG. 7.

### [Equation 7]

The linear part of the graph in FIG. 7A can be represented by the following equation.

$$q ( 1 ) = - \frac{{q}_{0}}{a} 1 + {q}_{0} \qquad ( 7 )$$

The permeation flux rate L for an infinitesimal length dl is represented as follows.

$$L = J \times dl \times π {d}_{i} [ {m}^{3} \text{/} s ] \\ q = ( q + \frac{d q}{d l} dl ) + L \\ 0 = \frac{d q}{d l} dl + ( J \times dl \times {πd}_{i} ) \\ \frac{d q}{d l} = - J \cdot π {d}_{i} \\ q ( 1 ) = - J π {d}_{i} \cdot 1 + {q}_{0} \qquad ( 8 )$$

(Note: d represents the inner diameter of the hollow fiber forward osmosis membrane)

### From Equations (7) and (8),

$$- \frac{{q}_{0}}{a} = - π {d}_{i} J \\ ∴ a = \frac{{q}_{0}}{π {d}_{i} J}$$

### [Equation 8]

A friction loss Δp up to a hollow fiber forward osmosis membrane distance a is acquired as follows:
Using a pressure drop head,

$$Δ h = λ \frac{1}{{d}_{i}} \cdot \frac{{V}^{2}}{2 g} ,$$

a laminar pipe friction coefficient

$$λ = \frac{64}{Re} ,$$

and the Reynolds number

$$Re = \frac{V \cdot {d}_{i}}{v} ,$$

Accordingly, the pressure drop head can be derived as follows.

$$Δ h = \frac{32 \cdot I \cdot v \cdot V}{{d}_{i}^{2} g}$$

Therefore, the pressure drop is expressed as follows.

$$p = pg Δ h = \frac{128 \cdot I \cdot v \cdot ρ}{π \cdot {d}_{i}^{4}} q ( Θ v = \frac{q}{\frac{π}{4} {d}_{i}^{2}} )$$

$$dp = \frac{128 \cdot v \cdot ρ}{π \cdot {d}_{i}^{4}} q \cdot dl$$

From the above, the following equation is acquired.

$$\begin{matrix}Δ p = {\int }_{0}^{a} \frac{128 \cdot \frac{μ}{ρ} \cdot ρ}{π \cdot {d}_{i}^{4}} q \cdot d l \\ = \frac{128 µ}{π {d}_{i}^{4}} {\int }_{0}^{a} ( - π {Jd}_{i} \cdot 1 + {q}_{0} ) d l \\ = \frac{128 µ}{π {d}_{i}^{4}} \{ - \frac{π {Jd}_{i}}{2} {a}^{2} + {q}_{0} a \} \\ = \frac{128 µ}{π {d}_{i}^{4}} \cdot \frac{{q}_{0}^{2}}{2 π {d}_{i} J} \\ = \frac{64 µ}{π {d}_{i}^{5} J} {q}_{0}^{2}\end{matrix}$$

### [Equation 9]

Therefore, the permeation flux rate per fiber and the permeation flux rate per entire element are expressed as follows.

$${q}_{0} = \sqrt{\frac{{π}^{2} {Jd}_{i}^{5} Δ p}{64 µ}} = \frac{π {d}_{i}^{2.5}}{8} \sqrt{\frac{J Δ p}{μ}} \\ Q = N \cdot {q}_{0} = \frac{A}{{d}_{o}^{2}} α \cdot \frac{π {d}_{i}^{2.5}}{8} \sqrt{\frac{J Δ p}{μ}} \qquad ( 9 )$$

[Equation 10] shows how the case of FIG. 6B in which water permeates through the entire hollow fiber forward osmosis membrane (the permeated water is partially returned) is theoretically calculated.

### [Equation 10]

The permeation flux rate per fiber q₀ is a product of an inner surface area π·di·l and the permeation flux rate per unit area J, expressed as follows.

q₀=π·dᵢ·L=J

From this, the permeation flux rate per element Q is expressed as follows. As will be seen, the permeation flux rate per element is dependent merely upon inner and outer diameters.

$$Q = N \cdot {q}_{0} = \frac{A}{{d}_{o}^{2}} α \cdot {q}_{0} = \frac{A}{{d}_{o}^{2}} α \cdot π \cdot {d}_{i} \cdot L \cdot J \qquad ( 10 )$$

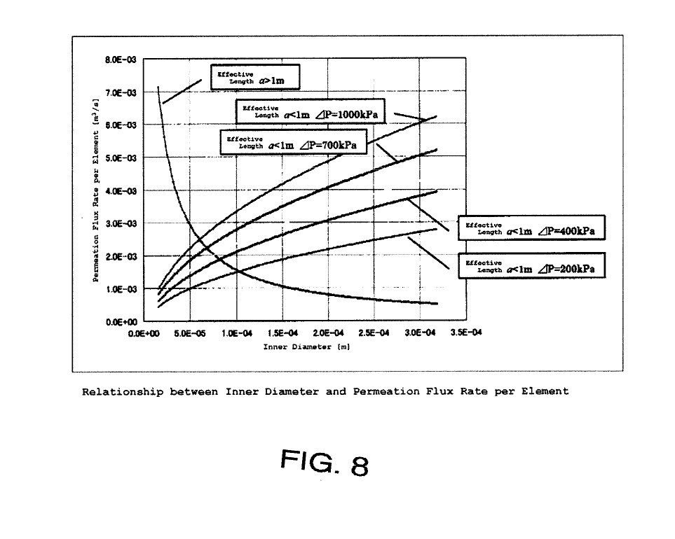

N: the number of hollow fiber forward osmosis membranes per element
A: the cross section area of a module
do: the outer diameter of the hollow fiber forward osmosis membrane
α: an effective packing ratio of hollow fiber forward osmosis membranes in the module
di: the inner diameter of the hollow fiber forward osmosis membrane
J: the permeation flux rate per unit area
Substituting J=3.426×10⁻⁶ [m/s], which is determined with reference to Honda, T., “Bulletin of the Society of Sea Water Science, Japan” Vol. 44, No. 6 (1990) into Equations (9) and (10), the graph in FIG. 8 can be drawn (1 is assumed to be 1 m).

### (4) Optimal Parameter Conditions of Hollow Fiber Forward Osmosis Membrane

Using the results of (1) to (3) described above, optimal conditions of the hollow fiber forward osmosis membrane are acquired.

Here, it is assumed as follows.

Unit internal efficiency k=Pt/Ps=0.95
Efficiency of the power recovery apparatus ηₓ=Pp/Ps=0.9
Flow rate ratio of the power recovery apparatus h=Qp/Qs=0.9
Seawater side pump efficiency ηₛ=0.85, the freshwater side pump
Efficiency η_{w}=0.85
Turbine pump efficiency ηₜ=0.85

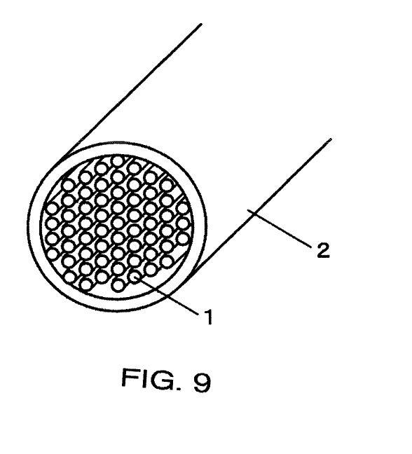

As shown in FIG. 9, it is assumed that a bunch of a plurality of hollow fiber forward osmosis membranes 1 (which is referred to as an “element” in the present specification) is tightly inserted inside of the cylindrical body 2 of 9 or 10 inch inner diameter. Parameters in both cases of 9 inch and 10 inch are shown in Tables 1 and 2 respectively. The overall efficiency ηₐₗₗ is acquired from the above described Equation (6) by changing the length of the hollow fiber forward osmosis membrane 1 and the permeation flux rate per unit area J, under conditions of Tables 1 and 2. As the membrane element of the hollow fiber forward osmosis membrane 1, HD10155EI (product of Toyobo Co., Ltd.) was employed.

TABLE 1
9 inch
(Sewage water) data from company
9 inch four ports type
May 19, 2009

| Pump efficiency ηₛ = | 0.9 | |
|---|---|---|
| η_{w} = | 0.85 | |
| Freshwater flow rate Qw = | 10.5 | l/min |
| Permeation flux rate Q′w = | 10.5 | l/min |
| Returned water = | 0 | |
| Freshwater side pressure Pw = | 500 | kPa |
| Concentrate seawater flow rate Qs = | 19.69 | l/min |
| Concentrate seawater pressure Ps = | 3 | Mpa |
| Mixed water flow rate Qs + Q′w = | 30.44 | l/min |
| Element outlet pressure Pt = | 2.53 | Mpa |

TABLE 2

| 10 inch | | |
|---|---|---|
| (Sewage water) data from company | | |
| 10 inch four ports type | | |
| Oct. 17, 2009 | | |
| Pump efficiency ηₛ = | 0.9 | |
| η_{w} = | 0.85 | |
| Freshwater flow rate Qw = | 10.99 | l/min |
| Permeation flux rate Q′w = | 10.18 | l/min |
| Returned water = | 0.81 | l/min |
| Freshwater side pressure Pw = | 500 | kPa |
| Concentrate seawater flow rate Qs = | 19.76 | l/min |
| Concentrate seawater pressure Ps = | 3 | Mpa |
| Mixed water flow rate Qs + Q′w = | 29.94 | l/min |
| Element outlet pressure Pt = | 2.5 | Mpa |

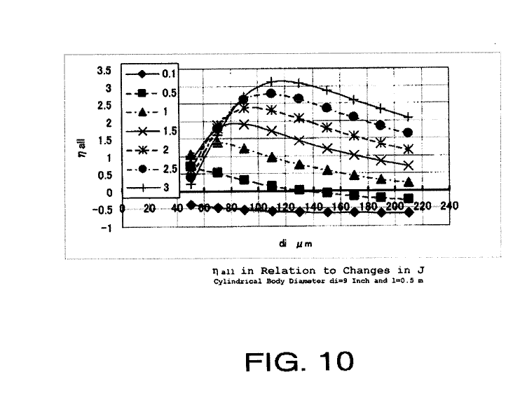

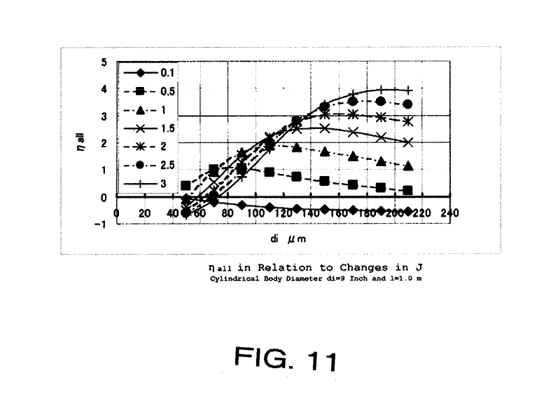

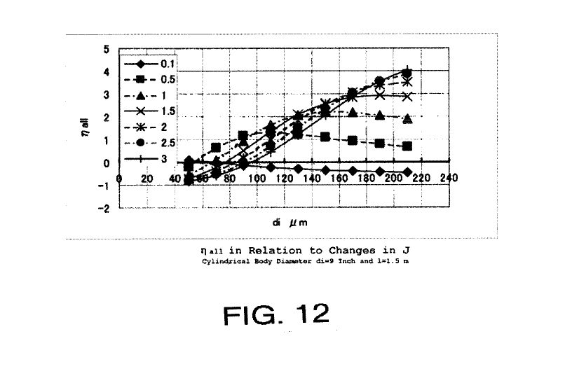

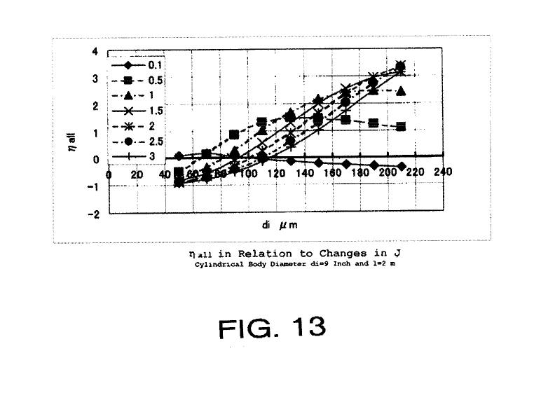

The overall efficiency ηₐₗₗ in a case in which a bundle of hollow fiber forward osmosis membranes is inserted into a 9 inch diameter cylindrical body is shown in Tables 3 to 6 and FIGS. 10 to 13. As described above, the overall efficiency ηₐₗₗ is acquired by dividing a net energy by the consumption energy, wherein the net energy is acquired by subtracting a consumption energy from an output energy. The output energy is an energy generated by the forward osmotic pressure power generation. The consumption energy is an energy consumed for operating the forward osmotic pressure power generation. For example, the overall efficiency being 3 means the net energy is 3 times larger than the consumption energy.

TABLE 3
Cylindrical Body Diameter 9 Inch
L = 0.5 m
ηₐₗₗ for 9 Inch Diameter and L = 0.5 m

| | J(rate to J0) | | | | | | |
|---|---|---|---|---|---|---|---|
| di | 0.1 | 0.5 | 1 | 1.5 | 2 | 2.5 | 3 |
| 50 | −0.37945 | 0.716485 | 1.061041 | 0.888566 | 0.631998 | 0.404132 | 0.219663 |
| 70 | −0.47188 | 0.534798 | 1.405177 | 1.803952 | 1.877579 | 1.781958 | 1.616068 |
| 90 | −0.52793 | 0.315553 | 1.230009 | 1.917013 | 2.364482 | 2.607023 | 2.696403 |
| 110 | −0.56511 | 0.146938 | 0.98011 | 1.710367 | 2.311969 | 2.777302 | 3.113179 |
| 130 | −0.59151 | 0.021047 | 0.76059 | 1.450783 | 2.074472 | 2.620337 | 3.083 |
| 150 | −0.6112 | −0.07489 | 0.582207 | 1.213776 | 1.809712 | 2.361839 | 2.864192 |
| 170 | −0.62644 | −0.14994 | 0.438367 | 1.012519 | 1.566564 | 2.095244 | 2.594139 |
| 190 | −0.63859 | −0.21009 | 0.321238 | 0.844236 | 1.355297 | 1.851086 | 2.328604 |
| 210 | −0.6485 | −0.2593 | 0.224527 | 0.703205 | 1.174469 | 1.636167 | 2.086299 |

TABLE 4
Cylindrical Body Diameter 9 Inch
L = 1 m
ηₐₗₗ for 9 Inch Diameter and L = 1 m

| | J(rate to J0) | | | | | | |
|---|---|---|---|---|---|---|---|
| di | 0.1 | 0.5 | 1 | 1.5 | 2 | 2.5 | 3 |
| 50 | −0.07054 | 0.390997 | −0.08726 | −0.35577 | −0.50736 | −0.60255 | −0.6674 |
| 70 | −0.211 | 1.003721 | 0.917678 | 0.545427 | 0.249649 | 0.036593 | −0.11888 |
| 90 | −0.31417 | 1.054322 | 1.644541 | 1.536974 | 1.252181 | 0.969113 | 0.72772 |
| 110 | −0.386 | 0.902646 | 1.892223 | 2.222487 | 2.178098 | 1.980206 | 1.740403 |
| 130 | −0.43789 | 0.723571 | 1.844861 | 2.50485 | 2.779856 | 2.804552 | 2.691394 |
| 150 | −0.47688 | 0.562967 | 1.682335 | 2.51016 | 3.035861 | 3.308432 | 3.396178 |
| 170 | −0.50719 | 0.427609 | 1.493082 | 2.378075 | 3.050792 | 3.515872 | 3.800958 |
| 190 | −0.53139 | 0.314847 | 1.311005 | 2.194089 | 2.933661 | 3.518542 | 3.953555 |
| 210 | −0.55116 | 0.220532 | 1.146637 | 2.000174 | 2.757175 | 3.403455 | 3.934294 |

TABLE 5
Cylindrical Body Diameter 9 Inch
L = 1.5 m
ηₐₗₗ for 9 Inch Diameter and L = 1.5 m

| | J(rate to J0) | | | | | | |
|---|---|---|---|---|---|---|---|
| di | 0.1 | 0.5 | 1 | 1.5 | 2 | 2.5 | 3 |
| 50 | 0.095828 | −0.19737 | −0.56228 | −0.70405 | −0.77717 | −0.8215 | −0.85119 |
| 70 | 0.011743 | 0.629237 | 0.096627 | −0.22041 | −0.40212 | −0.51695 | −0.59541 |
| 90 | −0.11298 | 1.164477 | 0.931219 | 0.509342 | 0.203697 | −0.00855 | −0.16061 |
| 110 | −0.21194 | 1.307992 | 1.648882 | 1.347299 | 0.99053 | 0.694386 | 0.462412 |
| 130 | −0.28661 | 1.239952 | 2.070123 | 2.088741 | 1.825996 | 1.517642 | 1.235763 |
| 150 | −0.34378 | 1.099249 | 2.215555 | 2.596381 | 2.5554 | 2.339419 | 2.074172 |
| 170 | −0.38862 | 0.947112 | 2.186516 | 2.85466 | 3.079948 | 3.040942 | 2.870403 |
| 190 | −0.42461 | 0.804989 | 2.070024 | 2.921595 | 3.383284 | 3.553007 | 3.534263 |
| 210 | −0.45407 | 0.678582 | 1.918725 | 2.867653 | 3.503681 | 3.866098 | 4.019171 |

TABLE 6
Cylindrical Body Diameter 9 Inch
L = 2 m
ηₐₗₗ for 9 Inch Diameter and L = 2 m

| | J(rate to J0) | | | | | | |
|---|---|---|---|---|---|---|---|
| di | 0.1 | 0.5 | 1 | 1.5 | 2 | 2.5 | 3 |
| 50 | 0.092958 | −0.51487 | −0.74961 | −0.83247 | −0.87429 | −0.89945 | −0.91624 |
| 70 | 0.16823 | 0.150267 | −0.3385 | −0.54756 | −0.65792 | −0.72544 | −0.77086 |
| 90 | 0.064169 | 0.851964 | 0.287302 | −0.07643 | −0.28911 | −0.42462 | −0.51759 |
| 110 | −0.04777 | 1.307369 | 1.01664 | 0.562872 | 0.241853 | 0.021036 | −0.13642 |
| 130 | −0.13995 | 1.475156 | 1.675842 | 1.2893 | 0.905937 | 0.605954 | 0.377732 |
| 150 | −0.21307 | 1.459349 | 2.140453 | 1.984591 | 1.633681 | 1.294339 | 1.008591 |
| 170 | −0.27139 | 1.358058 | 2.388464 | 2.547225 | 2.334593 | 2.02365 | 1.716585 |
| 190 | −0.31861 | 1.227238 | 2.465206 | 2.93076 | 2.92927 | 2.720481 | 2.444775 |
| 210 | −0.35749 | 1.093057 | 2.430921 | 3.142194 | 3.373347 | 3.321863 | 3.132023 |

For each curve in FIGS. 10 to 13, a ratio (di/L) between the inner diameter di and the length L of the hollow fiber forward osmosis membrane, which results in the maximum value of the overall efficiency ηₐₗₗ when the bundle of hollow fiber forward osmosis membranes is inserted in the 9 inch diameter cylindrical body, is shown only with effective number in Table 7.

TABLE 7
Ratio between di and L (di/L) at Each Maximum Value for 9 Inch
Diameter

| | J(rate to J0) | | | | | | |
|---|---|---|---|---|---|---|---|
| L | 0.1 | 0.5 | 1 | 1.5 | 2 | 2.5 | 3 |
| 0.5 | | | 144 | 166 | 190 | 220 | 234 |
| 1 | | 80 | 119 | 140 | 160 | 176 | 195 |
| 1.5 | 33.33333 | 70 | 103.3333 | 125.3333 | | | |
| 2 | 35 | 66.5 | 94 | | | | |

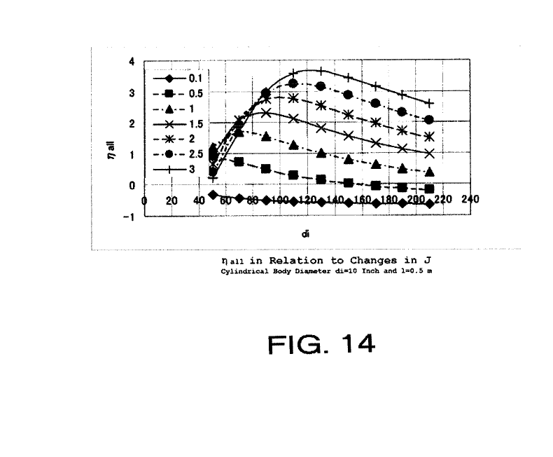

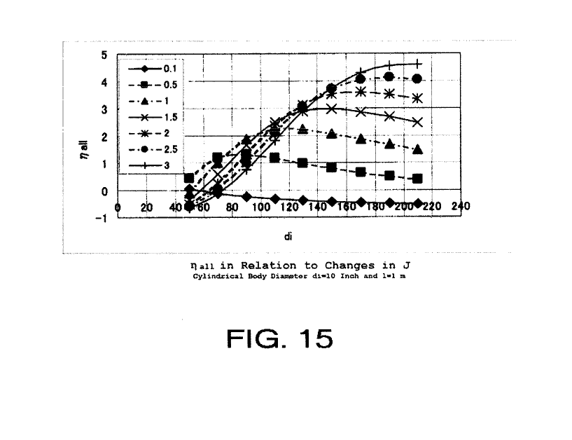

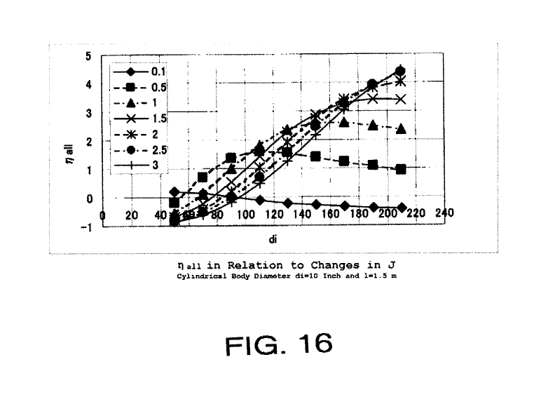

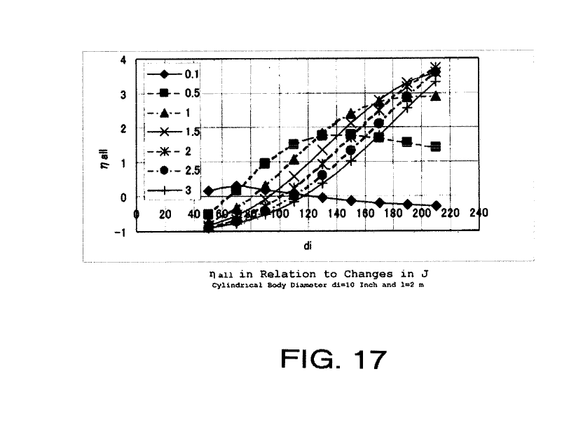

Next, the overall efficiency flail when a bundle of hollow fiber forward osmosis membranes are inserted into a 10 inch diameter cylindrical body is shown in Tables 8 to 11 and FIGS. 14 to 17.

TABLE 8
Cylindrical Body Diameter 10 Inch
L = 0.5 m
ηₐₗₗ for 10 Inch Diameter and L = 0.5 m

| | J(rate to J0) | | | | | | |
|---|---|---|---|---|---|---|---|
| di | 0.1 | 0.5 | 1 | 1.5 | 2 | 2.5 | 3 |
| 50 | −0.32308 | 0.917997 | 1.203178 | 0.956676 | 0.66138 | 0.41514 | 0.221821 |
| 70 | −0.43235 | 0.74676 | 1.700747 | 2.069595 | 2.07753 | 1.921332 | 1.709959 |
| 90 | −0.49885 | 0.497989 | 1.551169 | 2.30079 | 2.74793 | 2.953174 | 2.990579 |
| 110 | −0.54302 | 0.30104 | 1.276948 | 2.111365 | 2.773724 | 3.260535 | 3.587702 |
| 130 | −0.57438 | 0.152625 | 1.0249 | 1.828475 | 2.540721 | 3.148295 | 3.646826 |
| 150 | −0.59777 | 0.039101 | 0.816648 | 1.558473 | 2.250734 | 2.882766 | 3.447416 |
| 170 | −0.61589 | −0.04987 | 0.647442 | 1.324907 | 1.974226 | 2.588264 | 3.161257 |
| 190 | −0.63032 | −0.12124 | 0.509119 | 1.127795 | 1.729709 | 2.310245 | 2.865347 |
| 210 | −0.6421 | −0.17967 | 0.394656 | 0.961759 | 1.518432 | 2.061669 | 2.588709 |

TABLE 9
Cylindrical Body Diameter 10 Inch
L = 1 m
ηₐₗₗ for 10 Inch Diameter and L = 1 m

| | J(rate to J0) | | | | | | |
|---|---|---|---|---|---|---|---|
| di | 0.1 | 0.5 | 1 | 1.5 | 2 | 2.5 | 3 |
| 50 | 0.034359 | 0.442055 | −0.08576 | −0.36016 | −0.51217 | −0.60694 | −0.67127 |
| 70 | −0.1245 | 1.192945 | 0.989919 | 0.5659 | 0.252668 | 0.033451 | −0.12423 |
| 90 | −0.24548 | 1.316922 | 1.86037 | 1.654992 | 1.310441 | 0.996181 | 0.738611 |
| 110 | −0.33041 | 1.171489 | 2.226623 | 2.48931 | 2.359257 | 2.095919 | 1.812382 |
| 130 | −0.39192 | 0.974127 | 2.232036 | 2.898428 | 3.11281 | 3.061931 | 2.881707 |
| 150 | −0.43821 | 0.790209 | 2.076692 | 2.974908 | 3.493666 | 3.71618 | 3.738528 |
| 170 | −0.4742 | 0.632669 | 1.872988 | 2.867553 | 3.584125 | 4.041993 | 4.287852 |
| 190 | −0.50295 | 0.500355 | 1.668439 | 2.680508 | 3.499647 | 4.118016 | 4.54974 |
| 210 | −0.52643 | 0.389191 | 1.479864 | 2.469612 | 3.327407 | 4.037576 | 4.598428 |

TABLE 10
Cylindrical Body Diameter 10 Inch
L = 1.5 m
ηₐₗₗ for 10 Inch Diameter and L = 1.5 m

| | J(rate to J0) | | | | | | |
|---|---|---|---|---|---|---|---|
| di | 0.1 | 0.5 | 1 | 1.5 | 2 | 2.5 | 3 |
| 50 | 0.205429 | −0.19512 | −0.5666 | −0.70758 | −0.77995 | −0.82376 | −0.85307 |
| 70 | 0.131772 | 0.697675 | 0.101065 | −0.2247 | −0.40745 | −0.52198 | −0.59994 |
| 90 | −0.00918 | 1.351131 | 0.989227 | 0.522331 | 0.203154 | −0.01341 | −0.16678 |
| 110 | −0.12463 | 1.579824 | 1.815274 | 1.419406 | 1.018862 | 0.703292 | 0.462391 |
| 130 | −0.21263 | 1.543291 | 2.357658 | 2.266591 | 1.923795 | 1.569145 | 1.26147 |
| 150 | −0.28027 | 1.401749 | 2.593159 | 2.89925 | 2.762134 | 2.47221 | 2.157311 |
| 170 | −0.33342 | 1.234921 | 2.612575 | 3.266862 | 3.412676 | 3.287815 | 3.046564 |
| 190 | −0.37612 | 1.073685 | 2.512539 | 3.409659 | 3.831603 | 3.926673 | 3.829721 |
| 210 | −0.4111 | 0.927798 | 2.358166 | 3.398099 | 4.040437 | 4.357095 | 4.44185 |

TABLE 11
Cylindrical Body Diameter 10 Inch
L = 2 m
ηₐₗₗ for 10 Inch Diameter and L = 2 m

| | J(rate to J0) | | | | | | |
|---|---|---|---|---|---|---|---|
| di | 0.1 | 0.5 | 1 | 1.5 | 2 | 2.5 | 3 |
| 50 | 0.172687 | −0.51867 | −0.75272 | −0.83462 | −0.87591 | −0.90074 | −0.9173 |
| 70 | 0.300325 | 0.165872 | −0.34279 | −0.55225 | −0.66188 | −0.72875 | −0.77366 |
| 90 | 0.194524 | 0.941041 | 0.29613 | −0.08014 | −0.29481 | −0.43026 | −0.52278 |
| 110 | 0.067657 | 1.501349 | 1.073273 | 0.574588 | 0.240498 | 0.015635 | −0.14298 |
| 130 | −0.03962 | 1.752161 | 1.821013 | 1.345084 | 0.924741 | 0.609486 | 0.374667 |
| 150 | −0.12557 | 1.779108 | 2.393551 | 2.119374 | 1.699004 | 1.324158 | 1.020227 |
| 170 | −0.19445 | 1.689869 | 2.738705 | 2.786058 | 2.477075 | 2.10496 | 1.761609 |
| 190 | −0.25036 | 1.553795 | 2.884855 | 3.278027 | 3.172882 | 2.880762 | 2.547492 |
| 210 | −0.29645 | 1.406167 | 2.890838 | 3.583593 | 3.72708 | 3.582752 | 3.317266 |

For each curve in FIGS. 14 to 17, a ratio (di/L) between the inner diameter di and the length L of the hollow fiber forward osmosis membrane, which results in the maximum value of the overall efficiency ηₐₗₗ when the bundle of hollow fiber forward osmosis membranes is inserted in the inch diameter cylindrical body, is shown only with effective number in Table 12.

TABLE 12
Ratio between di and L (di/L) at Each Maximum Value for
10 Inch Diameter

| | J(rate to J0) | | | | | | |
|---|---|---|---|---|---|---|---|
| L | 0.1 | 0.5 | 1 | 1.5 | 2 | 2.5 | 3 |
| 0.5 | | 100 | 148 | 178 | 200 | 224 | 244 |
| 1 | 50 | 85 | 117 | 148 | 171 | 188 | 205 |
| 1.5 | 33.33333 | 78.66667 | 110 | 128.6667 | | | |
| 2 | 35 | 74 | 100 | | | | |

According to Tables 7 and 12, an equation that makes the optimal inner diameter (which results in the “maximum efficiency”) of the hollow fiber forward osmosis membrane converge to a constant value is expressed by [Equation 1]. Wherein the inner diameter changes from 50 μm and 200 μm, the length L of the hollow fiber forward osmosis membrane from 0.5 m to 2 m and the permeation flux rate J from J₀ to 2J₀ (J₀=3.42×10⁻⁷ m/s at 3 MPa).

Here, the inner diameter d is measured in μm, and the length L is measured in m.
d=50 to 200 μm

### L=0.5 to 2 m

### J=3.42×10⁻⁷ to 6.84×10⁻⁷ m/s

### [Equation 1]

$$\frac{d}{{L}^{0.75} + {J}^{0.5}} = 1.9 \times {10}^{5} ∼ 2.2 \times {10}^{5}$$

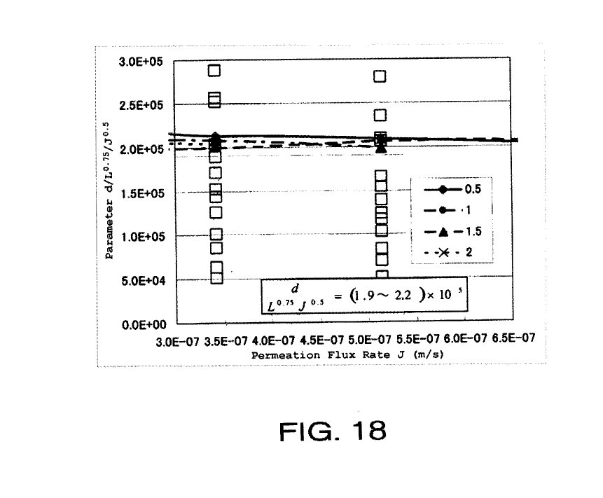

FIG. 18 shows the parameter d/(L^{0.75}·J^{0.5}) when the length L in [Equation 1] is specified in the range of L=0.5 to 2 m, similar to the specified range, it is evident that the parameter falls within the range.

### Second Embodiment

The description hereinafter is directed to how the relationship of optimal conditions for a hollow fiber forward osmosis membrane according to the present invention has been acquired.

In view of forward osmotic pressure power generation using a hollow fiber forward osmosis membrane, the presently employed hollow fiber type reverse osmosis membrane is insufficient to achieve an optimal situation. The inventor of the present invention has found optimal membrane conditions for forward osmotic pressure power generation by conducting following evaluations.

### (1) Optimal Thickness in Relation to Inner Diameter of Hollow Fiber Forward Osmosis Membrane

The hollow fiber osmosis membrane for reverse osmosis is used at a pressure of 8 MPa, while, on the other hand, the hollow fiber osmosis membrane for forward osmosis power generation is used at a pressure of 1.5 MPa, which is less than one fourth of the pressure in the case of the reverse osmosis. Accordingly, it appears possible to reduce the thickness of the hollow fiber forward osmosis membrane. The inventor of the present invention thought that great effect could be expected if the thickness of the membrane were reduced since concentration polarization within the membrane could be suppressed.

### (2) Calculation of System Efficiency

As described in the above, in order to acquire optimal parameters for forward osmotic pressure power generation, it is required to calculate the system efficiency. By calculating the system efficiency, it becomes possible to practically evaluate the forward osmotic pressure power generation.

### (3) Theoretical Calculation of Variation of Permeation Flux Rate Per Element in Relation to Variation of Inner Diameter of Hollow Fiber Forward Osmosis Membrane

In the case of the hollow fiber type reverse osmosis membrane, freshwater comes into the hollow fiber osmosis membrane as a result of high pressure on the side of saline water. On the other hand, in the case of the forward osmotic pressure power generation, since freshwater flowing in the hollow fiber osmosis membrane permeates on the side of seawater, the freshwater may completely permeates before reaching the end of the hollow fiber osmosis membrane, depending upon the amount of the flowing freshwater. On the other hand, if a sufficient amount of freshwater flows in the hollow fiber osmosis membrane, this results in a heavy loss in the view of power generation efficiency. Accordingly, it is required to find out optimal flowing conditions on the side of freshwater of the hollow fiber osmosis membrane in the forward osmotic pressure power generation.

(4) On the Bases of the Aforementioned Evaluations, Optimal Parameter Conditions have been Acquired for the Hollow Fiber Forward Osmosis Membrane.

### (1) Optimal Thickness in Relation to Inner Diameter of Hollow Fiber Forward Osmosis Membrane

Currently, the hollow fiber osmosis membrane for reverse osmosis is employed. This kind of hollow fiber forward osmosis membrane is designed to have a thickness sufficient not to break even under a pressure of 8 MPa. On the other hand, in the forward osmotic pressure power generation, experiments so far show that an optimal pressure is 1.5 MPa, i.e., less than one fourth is sufficient for pressure resistance. The optimal thickness in this case has been calculated as follows.

1) Theoretical calculation of a stress generated in the hollow fiber forward osmosis membrane.
2) Evaluation test of a yield stress of the hollow fiber forward osmosis membrane.
3) Calculation of an optimal thickness for use in the forward osmotic pressure power generation based on safety factor.

### 1) Theoretical Calculation of Stress Generated in Hollow Fiber Forward Osmosis Membrane

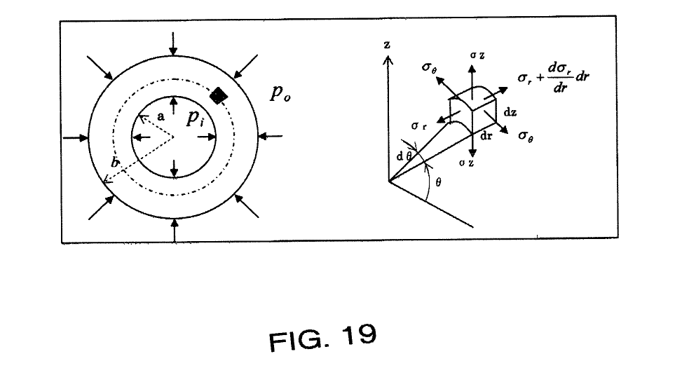

A stress in a circumferential direction generated by internal and external pressures exerted on the hollow fiber forward osmosis membrane shown in FIG. 19 can be expressed by the following [Equation 12]

### [Equation 12]

$${σ}_{r} = \frac{1}{{b}^{2} - {a}^{2}} \{ {P}_{i} \cdot {a}^{2} ( 1 - \frac{{b}^{2}}{{r}^{2}} ) - {P}_{o} \cdot {b}^{2} ( 1 - \frac{{a}^{2}}{{r}^{2}} ) \} \\ {σ}_{θ} = \frac{1}{{b}^{2} - {a}^{2}} \{ {P}_{i} \cdot {a}^{2} ( 1 + \frac{{b}^{2}}{{r}^{2}} ) - {P}_{o} \cdot {b}^{2} ( 1 + \frac{{a}^{2}}{{r}^{2}} ) \} \\ {σ}_{z} = 2 v \frac{{P}_{i} \cdot {a}^{2} - {P}_{o} \cdot {b}^{2}}{{b}^{2} - {a}^{2}} + E {ɛ}_{z} = v ( {σ}_{r } + {σ}_{z} ) + E {ɛ}_{z} \qquad ( 11 )$$

wherein Pₒ denotes an external pressure, Pᵢ denotes an internal pressure, a denotes an inner radius, b denotes an outer radius, σᵣ denotes a stress in a radial direction, σ_{θ} denotes a stress in a circumferential direction, and σ_{z} denotes a stress in an axial direction (see Saimoto, A., Hirano, T., Imai, Y. “Material Mechanics” pp. 108-110).

Since both ends of the hollow fiber forward osmosis membrane can be assumed to be open in this case, σ_{z}=0. Furthermore, owing to the condition Pₒ>>Pᵢ, |σᵣ|<|σ_{θ}|. Accordingly, σ_{θ} is the maximum stress in the hollow fiber forward osmosis membrane.

### 2) Evaluation Test of Yield Stress of Hollow Fiber Forward Osmosis Membrane

In order to prevent plastic deformation against the above described stress, an appropriate thickness is required. Therefore, an experiment has been conducted to calculate a yield point, and the optimal thickness has been considered in view of the yield point.

### Method of Experiment

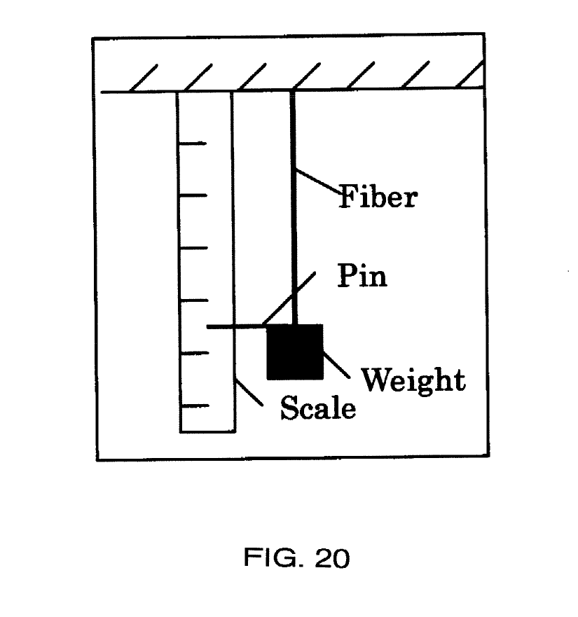

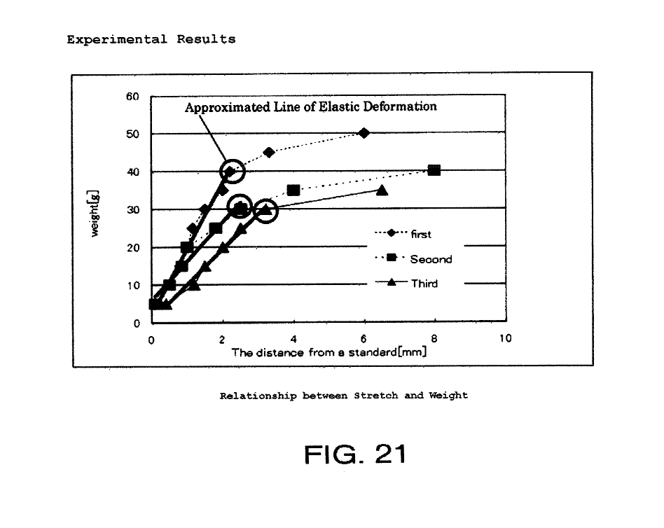

The yield stress has been acquired by conducting a tensile test as shown in FIG. 20. As an original point, a position at which the pin was placed when no weight was hung was marked on the scale. Firstly, a weight of 5 g was hung, and the distance the pin moved from the original point was measured on the scale. Then, the weight was removed, and it was checked whether or not the pin returned to the original point. In this manner, similar measurements were subsequently conducted with weights of 10 g, 15 g, . . . , 40 g, in ascending order of weight so as to ascertain a weight from which the plastic deformation begins to occur. Such experiments were repeated three times. The result of the experiments (relationship between stretch and weight) is shown in a graph of FIG. 21.

It is assumed that the plastic deformation begins to occur at the weight where a slope of the graph remarkably changes. Since, the second and third experiments showed the similar results in FIG. 3, it is determined that the plastic deformation begins at a weight of 30 g. Denoting a cross section area as A and a weight as F, the yield stress is calculated from the following equation [Equation 3]. This indicates that the value is approximately the same as that of nylon.

### [Equation 13]

Yield stress σ_{y} is expressed as follows.

$${σ}_{y} = \frac{F}{A} = \frac{30 \cdot {10}^{- 3} \cdot 9.8}{\frac{π}{4} ( {d}_{o}^{2} - {d}_{i}^{2} )} = 35.7 [ MPa ]$$

(nylon σ_{y}=40[MPa])

### 3) Calculation of Optimal Thickness for Use in Forward Osmotic Pressure Power Generation Based on Safety Factor

The currently employed hollow fiber forward osmosis membrane is designed to have a thickness sufficient not to break even under a pressure of 8 MPa. A theoretical radius a of the hollow fiber forward osmosis membrane is calculated as follows:

Firstly, as the actual hollow fiber forward osmosis membrane specifications, the values of the outer radius b=55 [μm], the external pressure Po=8 [MPa], and the internal pressure Pi=20 [kPa] are assigned to the term of theoretical stress σ_{θ} of the hollow fiber forward osmosis membrane in Equation (11). Then, assuming that the maximum stress position r=a, and using the yield stress σ_{y} calculated as a result of Equation (12), in view of σ_{θ}<σ_{y}, which is a condition for preventing the hollow fiber forward osmosis membrane from breaking, the theoretical radius a is acquired as 40 μm.

Accordingly, a theoretical thickness is acquired as follows.

t′=b−a=55−40=15 [μm].

However, the actual thickness is made thicker than the theoretical thickness in view of safety factor. Using the actual thickness t=35 [μm], the safety factor is acquired as follows.

s=35/15=2.333 . . . =2.5

Since the external pressure applied to the hollow fiber forward osmosis membrane is approximately 1.5 MPa in an actual environment, using a condition of the external pressure=1.5 MPa and the safety factor as acquired in the above, a thickness to which the safety factor is applied is estimated.

Equation (11) is calculated in a similar way, by merely changing the external pressure Po=1.5 Mpa in Equation (11), a theoretical inner radius a=52.5 [μm] is acquired. As a result of this, thickness t′=55−52.5=2.5 [μm] is acquired. In view of the safety factor, the thickness t is acquired as follows (outer radius standard).

t=s·t′=2.5×2.5=62.5 [μm]

Based on the above results, a relationship between thickness and inner diameter in view of the safety factor is acquired as follows.

t=0.048di+0.98×10⁻⁶ (13)

The thickness is expressed as follows.

do−di=2t (14)

di is acquired from Equation (13),

di=(do−1.96×10⁻⁶)/1.096 (15)

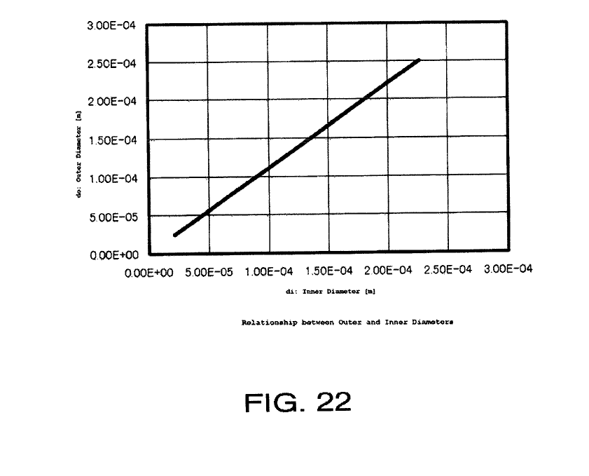

From equation (15), a relationship between outer and inner diameters is acquired, which is shown in FIG. 22.

### (2) Calculation of System Efficiency

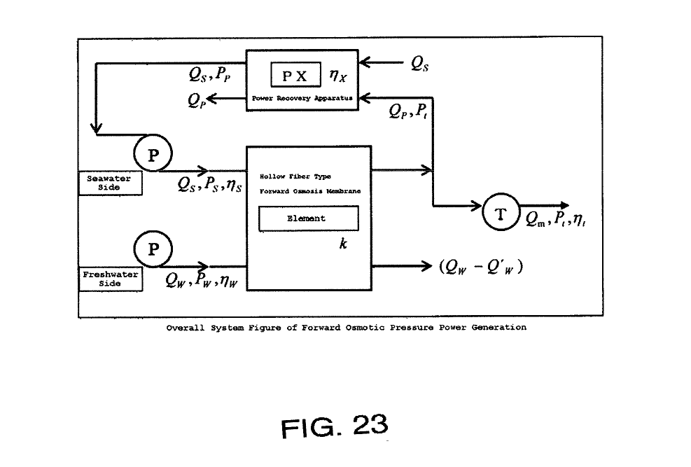

Here, instead of efficiency of a single hollow fiber forward osmosis membrane, efficiency of the entire forward osmotic pressure power generation system shown in FIG. 23 is considered. The explanation of reference numerals in FIG. 23 is shown in [Equation 14]. The calculation of system efficiency is shown in [Equation 15] and [Equation 16]. The power recovery apparatus in [Equation 15] is denoted by “PX” in FIG. 23.

### [Equation 14]

Seawater side pump power: Es
Freshwater side pump power: Ew
Seawater side pump efficiency: ηₛ
Freshwater side pump efficiency: η_{w}
Seawater side pump pressure: Ps
Freshwater side pump pressure: Pw
Seawater side pump compression flow rate: Qs
Freshwater side pump compression flow rate: Qw
Turbine flow rate: Qm
Permeation flux rate: Q′w
Turbine output: Et
Turbine efficiency: ηₜ
Power recovery apparatus efficiency: ηₓ
Power recovery apparatus outlet pressure: Pp

### [Equation 15]

### Output

Eₜ=ηₜPₜ·Qₘ

### Power

$${E}_{s} = \frac{( {P}_{s} - {P}_{p} ) {Q}_{s}}{{η}_{s}}$$

$${E}_{w} = \frac{{P}_{w} \cdot {Q}_{w}}{{η}_{w}}$$

Flow rate

Qₘ=(Qₛ+Q′_{w})−Qₚ

Loss in a unit

Pₜ=kPₛ

The net output calculated from the above equations is expressed as follows.

$$\begin{matrix}{E}_{n} = {E}_{t} - ( {E}_{s} + {E}_{w} ) \\ = {η}_{t} \cdot {P}_{t} \cdot {Q}_{m} - ( \frac{( {P}_{s} - {P}_{p} ) {Q}_{s}}{{η}_{s}} + \frac{{P}_{w} \cdot {Q}_{w}}{{η}_{w}} ) \\ = {η}_{t} \cdot {kP}_{s} ( {Q}_{s} + {Q}_{w}^{′} - {Q}_{p} ) - ( \frac{( {P}_{s} - {P}_{p} ) {Q}_{s}}{{η}_{s}} + \frac{{P}_{w} \cdot {Q}_{w}}{{η}_{w}} )\end{matrix}$$

Since the following conditions are required in the power recovery apparatus,

Qₚ=hQₛ(h≅1),

The following condition is required.

Pₚ=ηₓkPₛ

Accordingly, it follows that

$${E}_{n} = {η}_{t} \cdot {kP}_{s} ( {Q}_{w}^{′} + ( 1 - h ) {Q}_{s} ) - \frac{1 - k {η}_{x}}{{η}_{s}} {P}_{s} {Q}_{s} - \frac{{P}_{w} \cdot {Q}_{w}}{{η}_{w}}$$

### [Equation 16]

Defining a permeating rate x (1>x) as a rate of freshwater permeating into seawater, a flow rate between inlet and outlet on the freshwater side is expressed as follows.

Q′_{w}=Q_{w}·x.

Defining y (1>>y) as a ratio of freshwater side pressure to seawater side pressure, Pw/Ps=y follows.
Defining z (1>z) as a ratio of freshwater side inlet flow rate to seawater side flow rate,

Qw/Qs=z follows.

Using the above definitions,

$$\begin{matrix}{E}_{n} = k {η}_{t} {P}_{s} \{ ( 1 - h ) {Q}_{s} + {xzQ}_{s} \} - ( \frac{1 - k {η}_{x}}{{η}_{s}} {P}_{s} {Q}_{s} + \frac{yz}{{η}_{w}} {P}_{s} {Q}_{s} ) \\ = \{ k {η}_{t} ( 1 - h ) + k {η}_{t} xz - \frac{1 - k {η}_{x}}{{η}_{s}} - \frac{yz}{{η}_{w}} \} {P}_{s} {Q}_{s}\end{matrix}$$

Thus, the overall efficiency is expressed as follows.

$${η}_{all} = \frac{{E}_{n}}{{E}_{s} + {E}_{w}} = \frac{\{ k {η}_{t} ( 1 - h ) + k {η}_{t} xz - \frac{1 - k {η}_{x}}{{η}_{s}} - \frac{yz}{{η}_{w}} \} {P}_{s} {Q}_{s}}{( \frac{1 - k {η}_{x}}{{η}_{s}} + \frac{yz}{{η}_{w}} ) {P}_{s} {Q}_{s}} \qquad ( 16 )$$

The overall efficiency ηₐₗₗ of Equation (16) is acquired by dividing net energy by consumption energy, wherein the net energy is acquired by subtracting consumption energy from output energy. The output energy is energy generated by the forward osmotic pressure power generation. The consumption energy is energy consumed for operating the forward osmotic pressure power generation.

### (3) Theoretical Calculation of Variation of Permeation Flux Rate Per Element in Relation to Variation of Hollow Fiber Forward Osmosis Membrane Inner Diameter

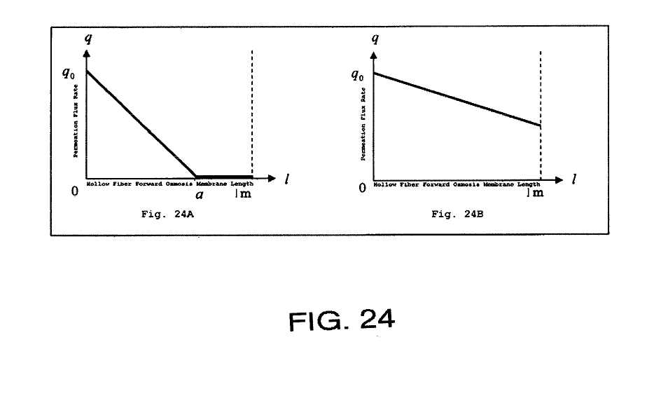

FIG. 24 shows the permeation flux rate per hollow fiber forward osmosis membrane in relation to changes in length. Here, FIG. 24A shows a case in which water completely permeates before reaching the end of the hollow fiber forward osmosis membrane, and FIG. 24B shows a case in which water permeates through the entire hollow fiber forward osmosis membrane (the permeated water is partially returned).

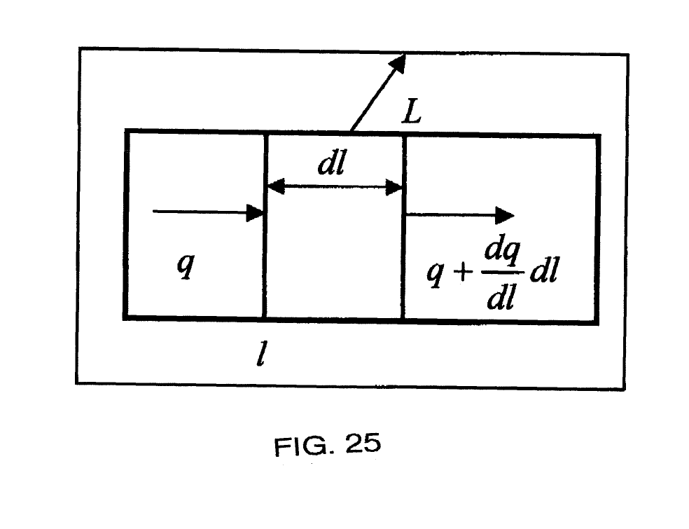

Assuming the length of the hollow fiber forward osmosis membrane to be 1 m, two cases of FIGS. 24A and 24B are considered. As for the case of FIG. 24A, water permeates before reaching 1 m. On the other hand, as for the case of FIG. 24B, water permeates through the entire hollow fiber forward osmosis membrane.

[Equation 17] to [Equation 19] show how the case of FIG. 24A in which water completely permeates before reaching the end of the hollow fiber forward osmosis membrane is theoretically calculated with reference to FIG. 25.

### [Equation 17]

The linear part of the graph in FIG. 25A can be represented by the following equation.

$$q ( 1 ) = - \frac{{q}_{0}}{a} 1 + {q}_{0} \qquad ( 17 )$$

The permeation flux rate L for an infinitesimal length dl is represented as follows.

$$L = J \times dl \times π {d}_{i} [ {m}^{3} / s ] \\ q = ( q + \frac{d q}{d l} dl ) + L \\ 0 = \frac{d q}{d l} dl + ( J \times dl \times π {d}_{i} ) \\ \frac{d q}{d l} = - J \cdot π {d}_{i} \\ q ( l ) = - J π {d}_{i} \cdot 1 + {q}_{0} \qquad ( 18 )$$

(Note: d represents the inner diameter of the hollow fiber forward osmosis membrane)

### From Equations (17) and (18),

$$- \frac{{q}_{0}}{a} = - π {d}_{i} J \\ ∴ a = \frac{{q}_{0}}{π {d}_{i} J}$$

### [Equation 18]

A friction loss Δp up to a hollow fiber forward osmosis membrane distance a is acquired as follows:
Using a pressure drop head

$$Δ h = λ \frac{1}{{d}_{i}} \cdot \frac{{V}^{2}}{2 {g}^{′}}$$

a laminar pipe friction coefficient

$$λ = \frac{64}{{Re}^{′}}$$

and the Reynolds number

$$Re = \frac{V \cdot {d}_{i}}{v} ,$$

Accordingly, the pressure drop head can be derived as follows.

$$Δ h = \frac{32 \cdot l \cdot v \cdot V}{{d}_{i}^{2} g}$$

Therefore, the pressure drop is expressed as follows.

$$p = ρ g Δ h = \frac{128 \cdot l \cdot v \cdot ρ}{π \cdot {d}_{i}^{4}} q ( Θ v = \frac{q}{\frac{π}{4} {d}_{i}^{2}} )$$

$$dp = \frac{128 \cdot v \cdot ρ}{π \cdot {d}_{i}^{4}} q \cdot dl$$

From the above, the following equation is acquired.

$$\begin{matrix}Δ p = {\int }_{0}^{a} \frac{128 \cdot \frac{μ}{ρ} \cdot ρ}{π \cdot {d}_{i}^{4}} q \cdot d l \\ = \frac{128 μ}{π {d}_{i}^{4}} {\int }_{0}^{a} ( - π {Jd}_{i} \cdot 1 + {q}_{0} ) d l \\ = \frac{128 μ}{π {d}_{i}^{4}} \{ - \frac{π {Jd}_{i}}{2} {a}^{2} + {q}_{0} a \} \\ = \frac{128 μ}{π {d}_{i}^{4}} \cdot \frac{{q}_{0}^{2}}{2 π {d}_{i} J} \\ = \frac{64 μ}{{π}^{2} {d}_{i}^{5} J} {q}_{0}^{2}\end{matrix}$$

### [Equation 19]

Therefore, the permeation flux rate per fiber and the permeation flux rate per entire element are expressed as follows.

$${q}_{0} = \sqrt{\frac{{π}^{2} {Jd}_{i}^{5} Δ p}{64 μ}} = \frac{π {d}_{i}^{2 \cdot 5}}{8} \sqrt{\frac{J Δ p}{μ}} \\ Q = N \cdot {q}_{0} = \frac{A}{{d}_{0}^{2}} α \cdot \frac{π {d}_{i}^{2 \cdot 5}}{8} \sqrt{\frac{J Δ p}{μ}} \qquad ( 19 )$$

[Equation 20] shows how the case of FIG. 24B in which water permeates through the entire hollow fiber forward osmosis membrane (the permeated water is partially returned) is theoretically calculated.

### [Equation 20]

The permeation flux rate per fiber q₀ is a product of an inner surface area π·di·l and the permeation flux rate per unit area J, expressed as follows.

q₀=π·dᵢ·L=J

From this, the permeation flux rate per element Q is expressed as follows. As will be seen, the permeation flux rate per element Q is dependent merely upon inner and outer diameters.

$$Q = N \cdot {q}_{0} = \frac{A}{{d}_{0}^{2}} α \cdot {q}_{0} = \frac{A}{{d}_{0}^{2}} α \cdot π \cdot {d}_{i} \cdot L \cdot J \qquad ( 20 )$$

N: the number of hollow fiber forward osmosis membranes per element
A: the cross section area of a module
do: the outer diameter of the hollow fiber forward osmosis membrane
α: an effective packing ratio of hollow fiber forward osmosis membranes in the module
di: the inner diameter of the hollow fiber forward osmosis membrane
J: the permeation flux rate per unit area

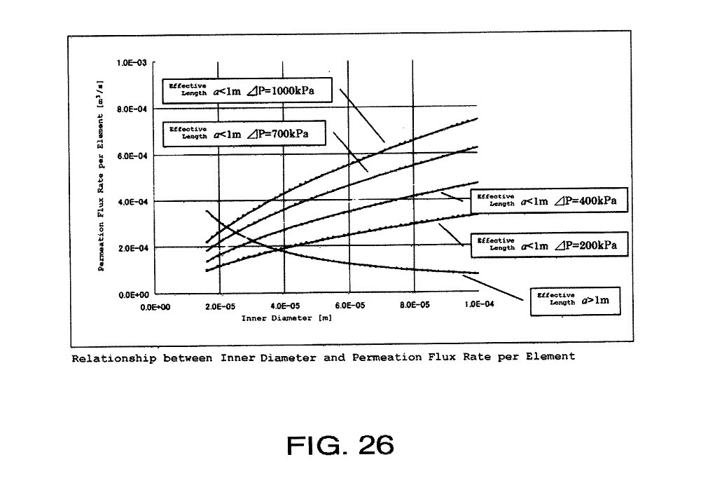

Substituting J=1.713×10⁻⁷ [m/s], which is determined in view of the permeation flux rate in an actual reverse osmosis with reference to Honda, T., “Bulletin of the Society of Sea Water Science, Japan” Vol. 44, No. 6 (1990), into Equations (19) and (20), the graph in FIG. 26 can be drawn (1 is assumed to be 1 m).

### (4) Optimal Condition Parameter of Hollow Fiber Forward Osmosis Membrane

Using the results of (1) to (3) described above, optimal conditions of the hollow fiber forward osmosis membrane are acquired.

Here, it is assumed as follows.

Unit internal efficiency k=Pt/Ps=0.95
Efficiency of the power recovery apparatus ηₓ=Pp/Ps=0.9
Flow rate ratio of the power recovery apparatus h=Qp/Qs=0.9
Seawater side pump efficiency ηₛ=0.85
Freshwater side pump efficiency η_{w}=0.85
Turbine pump efficiency ηₜ=0.85.

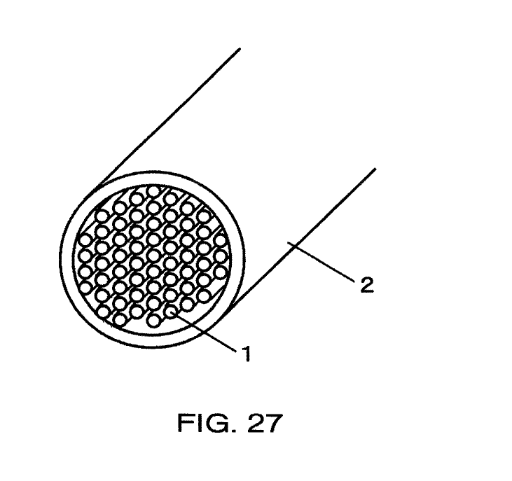

As shown in FIG. 27, it is assumed that a bunch of a plurality of hollow fiber forward osmosis membranes 1 is tightly inserted inside of the cylindrical body 2 of 9 or 10 inch inner diameter. Parameters in both cases of 9 inch and 10 inch are shown in Tables 13 and 14 respectively. The overall efficiency ηₐₗₗ is acquired from the above described Equation (16) by changing the length of the hollow fiber forward osmosis membrane L and the permeation flux rate per unit area J, under conditions of Tables 13 and 14. As the membrane element of the hollow fiber forward osmosis membrane 1, HD10155EI (product of Toyobo Co., Ltd.) was employed.

TABLE 13
9 inch four ports type
Estimated values derived from concentrate seawater data

| Pump efficiency ηₛ = | 0.9 | |
|---|---|---|
| η_{w} = | 0.85 | |
| Freshwater flow rate Qw = | 5.25 | l/min |
| Permeation flux rate Q′w = | 5.25 | l/min |
| Returned water = | 0 | |
| Freshwater side pressure Pw = | 500 | kPa |
| Concentrate seawater flow rate Qs = | 19.69 | l/min |
| Concentrate seawater pressure Ps = | 1.5 | Mpa |
| Mixed water flow rate Qs + Q′w = | 24.94 | l/min |
| Element outlet pressure Pt = | 1.25 | Mpa |

TABLE 14
10 inch four ports type
Estimated values from concentrate seawater data

| Pump efficiency ηₛ = | 0.9 | |
|---|---|---|
| η_{w} = | 0.85 | |
| Freshwater flow rate Qw == | 5.5 | l/min |
| Permeation flux rate Q′w = | 5.1 | l/min |
| Returned water = | 0.4 | l/min |
| Freshwater side pressure Pw = | 500 | kPa |
| Concentrate seawater flow rate Qs = | 19.76 | l/min |
| Concentrate seawater pressure Ps = | 1.5 | Mpa |
| Mixed water flow rate Qs + Q′w = | 24.86 | l/min |
| Element outlet pressure Pt = | 1.25 | Mpa |

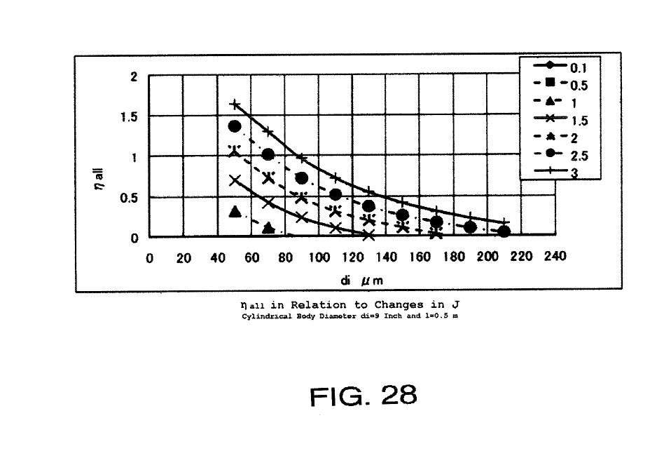

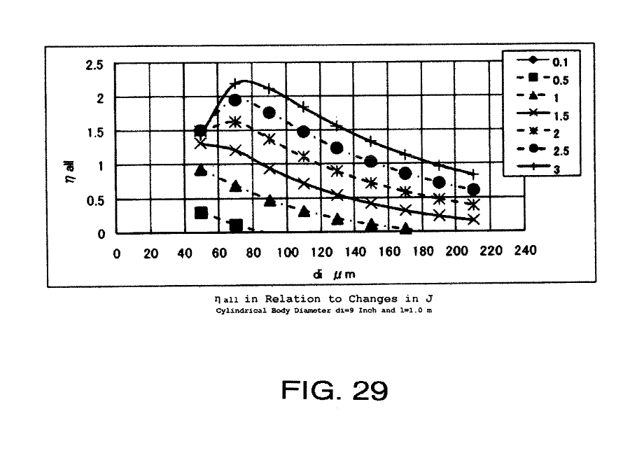

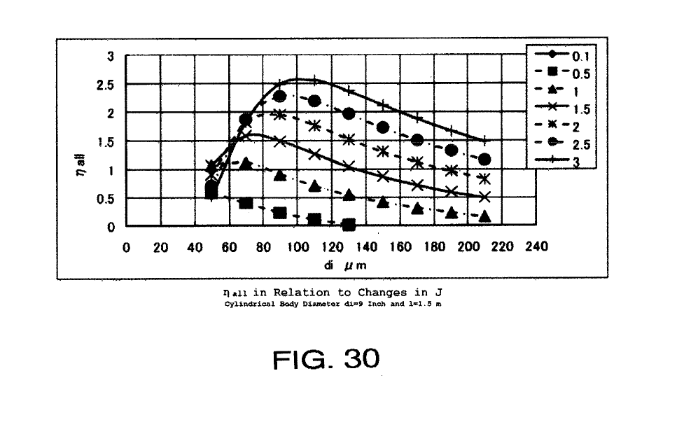

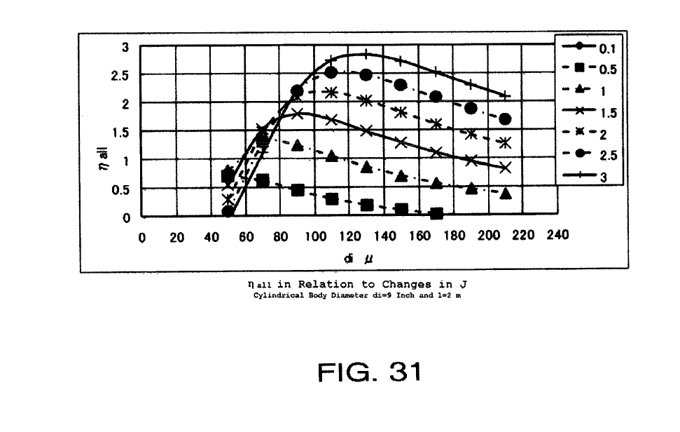

The overall efficiency ηₐₗₗ when a bundle of hollow fiber forward osmosis membranes are inserted into a 9 inch diameter cylindrical body is shown in Tables 15 to 18 and FIGS. 28 to 31. As described above, the overall efficiency ηₐₗₗ is acquired by dividing a net energy, which has been acquired by subtracting a consumption energy from an output energy, by the consumption energy. The output energy is an energy generated by the forward osmotic pressure power generation. The consumption energy is an energy consumed for the power generation. For example, the overall efficiency being 3 means the net energy is 3 times larger than the consumption energy.

TABLE 15
Cylindrical Body Diameter 9 Inch
L = 0.5 m
ηₐₗₗ for 9 Inch Diameter and L = 0.5 m

| | J(rate to J0) | | | | | | |
|---|---|---|---|---|---|---|---|
| di | 0.1 | 0.5 | 1 | 1.5 | 2 | 2.5 | 3 |
| 50 | −0.44005 | −0.09733 | 0.31601 | 0.70303 | 1.05545 | 1.36752 | 1.63614 |
| 70 | −0.46253 | −0.20696 | 0.10917 | 0.41946 | 0.72174 | 1.01403 | 1.29456 |
| 90 | −0.47577 | −0.27260 | −0.01971 | 0.23135 | 0.47987 | 0.72521 | 0.96674 |
| 110 | −0.48449 | −0.31600 | −0.10583 | 0.10360 | 0.31205 | 0.51925 | 0.72494 |
| 130 | −0.49065 | −0.34678 | −0.16714 | 0.01216 | 0.19100 | 0.36928 | 0.54687 |
| 150 | −0.49525 | −0.36972 | −0.21292 | −0.05630 | 0.10009 | 0.25619 | 0.41194 |
| 170 | −0.49880 | −0.38748 | −0.24839 | −0.10940 | 0.02946 | 0.16816 | 0.30667 |
| 190 | −0.50163 | −0.40163 | −0.27667 | −0.15176 | −0.02693 | 0.09780 | 0.22242 |
| 210 | −0.50394 | −0.41317 | −0.29973 | −0.18633 | −0.07298 | 0.04032 | 0.15354 |

TABLE 16
Cylindrical Body Diameter 9 Inch
L = 1 m
ηₐₗₗ for 9 Inch Diameter and L = 1 m
J(rate to J0)

| di | 0.1 | 0.5 | 1 | 1.5 | 2 | 2.5 | 3 |
|---|---|---|---|---|---|---|---|
| 50 | −0.35420 | 0.29257 | 0.92318 | 1.30737 | 1.47742 | 1.50010 | 1.43631 |
| 70 | −0.39861 | 0.10370 | 0.68877 | 1.20022 | 1.62118 | 1.94666 | 2.18124 |
| 90 | −0.42497 | −0.02152 | 0.46904 | 0.93492 | 1.36762 | 1.76069 | 2.10989 |
| 110 | −0.44236 | −0.10659 | 0.30766 | 0.71205 | 1.10285 | 1.47674 | 1.83085 |
| 130 | −0.45469 | −0.16750 | 0.18893 | 0.54085 | 0.88648 | 1.22417 | 1.55239 |
| 150 | −0.46387 | −0.21312 | 0.09900 | 0.40881 | 0.71540 | 1.01792 | 1.31553 |
| 170 | −0.47097 | −0.24851 | 0.02884 | 0.30490 | 0.57918 | 0.85120 | 1.12049 |
| 190 | −0.47663 | −0.27674 | −0.02731 | 0.22135 | 0.46896 | 0.71524 | 0.95991 |
| 210 | −0.48125 | −0.29978 | −0.07322 | 0.15286 | 0.37829 | 0.60289 | 0.82649 |

TABLE 17
Cylindrical Body Diameter 9 Inch
L = 1.5 m
ηₐₗₗ for 9 Inch Diameter and L = 1.5 m

| | J(rate to J0) | | | | | | |
|---|---|---|---|---|---|---|---|
| di | 0.1 | 0.5 | 1 | 1.5 | 2 | 2.5 | 3 |
| 50 | −0.27019 | 0.57721 | 1.05150 | 1.06190 | 0.89545 | 0.69485 | 0.50839 |
| 70 | −0.33513 | 0.38870 | 1.11333 | 1.57938 | 1.81050 | 1.87145 | 1.82653 |
| 90 | −0.37433 | 0.22118 | 0.90411 | 1.48256 | 1.93666 | 2.26531 | 2.48075 |
| 110 | −0.40031 | 0.09944 | 0.69935 | 1.25487 | 1.75210 | 2.18226 | 2.54173 |
| 130 | −0.41875 | 0.01018 | 0.53487 | 1.03873 | 1.51412 | 1.95488 | 2.35646 |
| 150 | −0.43250 | −0.05735 | 0.40569 | 0.85800 | 1.29543 | 1.71427 | 2.11134 |
| 170 | −0.44315 | −0.11000 | 0.30313 | 0.71031 | 1.10916 | 1.49749 | 1.87329 |
| 190 | −0.45164 | −0.15213 | 0.22029 | 0.58918 | 0.95314 | 1.31083 | 1.66098 |
| 210 | −0.45856 | −0.18657 | 0.15219 | 0.48874 | 0.82223 | 1.15180 | 1.47666 |

TABLE 18
Cylindrical Body Diameter 9 Inch
L = 2 m
ηₐₗₗ for 9 Inch Diameter and L = 2 m

| | J(rate to J0) | | | | | | |
|---|---|---|---|---|---|---|---|
| di | 0.1 | 0.5 | 1 | 1.5 | 2 | 2.5 | 3 |
| 50 | −0.18944 | 0.70390 | 0.80650 | 0.55111 | 0.29378 | 0.09034 | −0.06516 |
| 70 | −0.27242 | 0.62649 | 1.30454 | 1.51715 | 1.46412 | 1.30246 | 1.11255 |
| 90 | −0.32394 | 0.44783 | 1.24182 | 1.78170 | 2.07901 | 2.19018 | 2.17781 |
| 110 | −0.35836 | 0.29895 | 1.04902 | 1.67761 | 2.16308 | 2.50638 | 2.72365 |
| 130 | −0.38287 | 0.18482 | 0.86087 | 1.47699 | 2.01562 | 2.46722 | 2.82979 |
| 150 | −0.40117 | 0.09683 | 0.70202 | 1.27567 | 1.80672 | 2.28691 | 2.71100 |
| 170 | −0.41535 | 0.02760 | 0.57163 | 1.09795 | 1.59985 | 2.07164 | 2.50884 |
| 190 | −0.42666 | −0.02807 | 0.46443 | 0.94641 | 1.41372 | 1.86265 | 2.28995 |
| 210 | −0.43588 | −0.07370 | 0.37542 | 0.81799 | 1.25137 | 1.67312 | 2.08100 |

For each curve line in FIGS. 28 to 31, a ratio (di/L) between the inner diameter di and the length L of the hollow fiber forward osmosis membrane, which results in the maximum value of the overall efficiency ηₐₗₗ when the bundle of hollow fiber forward osmosis membranes is inserted in the 9 inch diameter cylindrical body, is shown only with effective number in Table 19.

TABLE 19
Ratio between di and L (di/L) at Each Maximum Value for
9 Inch Diameter

| | J(rate to J0) | | | | | | |
|---|---|---|---|---|---|---|---|
| L | 0.1 | 0.5 | 1 | 1.5 | 2 | 2.5 | 3 |
| 0.5 | | | | | | 116 | 134 |
| 1 | | | | | 70 | 71 | 75 |
| 1.5 | | | 43.3333 | 49.3333 | 55.3333 | 61.3333 | 67.3333 |
| 2 | | | 39.5 | 46 | 53 | 57.5 | 63 |

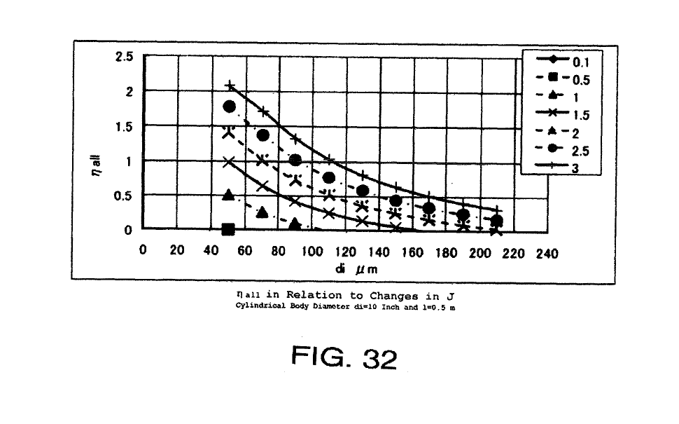

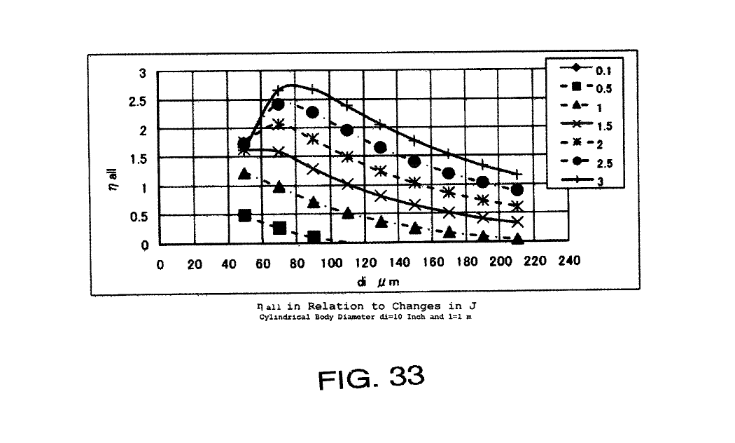

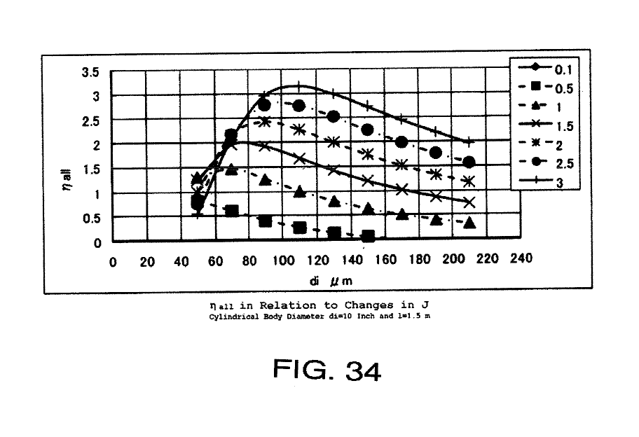

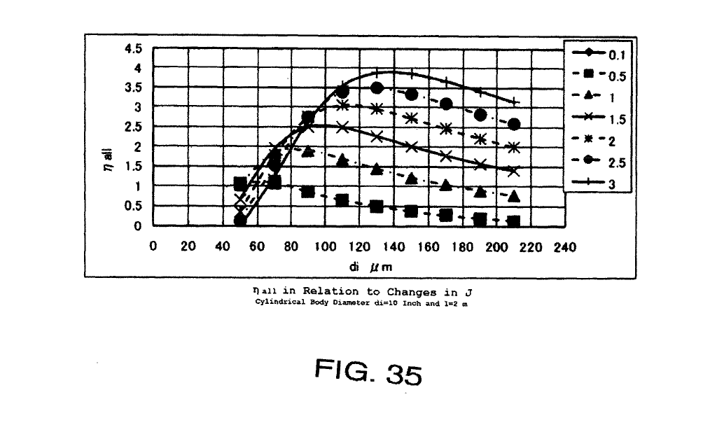

Next, the overall efficiency ηₐₗₗ when a bundle of hollow fiber forward osmosis membranes are inserted into a 10 inch diameter cylindrical body is shown in Tables 20 to 23 and FIGS. 32 to 35.

TABLE 20
Cylindrical Body Diameter 10 Inch
L = 0.5 m
ηₐₗₗ for 10 Inch Diameter and L = 0.5 m

| | J(rate to J0) | | | | | | |
|---|---|---|---|---|---|---|---|
| di | 0.1 | 0.5 | 1 | 1.5 | 2 | 2.5 | 3 |
| 50 | −0.41866 | 0.00812 | 0.51950 | 0.99186 | 1.41335 | 1.77661 | 2.07876 |
| 70 | −0.44669 | −0.12810 | 0.26528 | 0.64998 | 1.02269 | 1.38045 | 1.72069 |
| 90 | −0.46321 | −0.20987 | 0.10525 | 0.41764 | 0.72625 | 1.03008 | 1.32815 |
| 110 | −0.47407 | −0.26398 | −0.00198 | 0.25894 | 0.51839 | 0.77596 | 1.03126 |
| 130 | −0.48176 | −0.30235 | −0.07837 | 0.14511 | 0.36792 | 0.58987 | 0.81080 |
| 150 | −0.48749 | −0.33096 | −0.13544 | 0.05982 | 0.25474 | 0.44922 | 0.64318 |
| 170 | −0.49193 | −0.35310 | −0.17966 | −0.00636 | 0.16674 | 0.33961 | 0.51219 |
| 190 | −0.49546 | −0.37075 | −0.21492 | −0.05917 | 0.09646 | 0.25195 | 0.40728 |
| 210 | −0.49834 | −0.38514 | −0.24368 | −0.10227 | 0.03907 | 0.18031 | 0.32146 |

TABLE 21
Cylindrical Body Diameter 10 Inch
L = 1 m
ηₐₗₗ for 10 Inch Diameter and L = 1 m

| | J(rate to J0) | | | | | | |
|---|---|---|---|---|---|---|---|
| di | 0.1 | 0.5 | 1 | 1.5 | 2 | 2.5 | 3 |
| 50 | −0.31168 | 0.48606 | 1.22566 | 1.62771 | 1.76250 | 1.73286 | 1.61878 |
| 70 | −0.36700 | 0.25752 | 0.97484 | 1.58397 | 2.06387 | 2.41297 | 2.64360 |
| 90 | −0.39986 | 0.10270 | 0.71055 | 1.28155 | 1.80331 | 2.26712 | 2.66815 |
| 110 | −0.42155 | −0.00303 | 0.51206 | 1.01239 | 1.49233 | 1.94696 | 2.37230 |
| 130 | −0.43691 | −0.07887 | 0.36496 | 0.80202 | 1.22963 | 1.64527 | 2.04667 |
| 150 | −0.44836 | −0.13571 | 0.25319 | 0.63864 | 1.01926 | 1.39372 | 1.76076 |
| 170 | −0.45722 | −0.17982 | 0.16587 | 0.50964 | 0.85074 | 1.18843 | 1.52199 |
| 190 | −0.46428 | −0.21501 | 0.09593 | 0.40575 | 0.71399 | 1.02021 | 1.32400 |
| 210 | −0.47004 | −0.24374 | 0.03873 | 0.32049 | 0.60128 | 0.88082 | 1.15884 |

TABLE 22
Cylindrical Body Diameter 10 Inch
L = 1.5 m
ηₐₗₗ for 10 Inch Diameter and L = 1.5 m

| | J(rate to J0) | | | | | | |
|---|---|---|---|---|---|---|---|
| di | 0.1 | 0.5 | 1 | 1.5 | 2 | 2.5 | 3 |
| 50 | −0.20723 | 0.81324 | 1.29193 | 1.22551 | 0.99622 | 0.75663 | 0.54717 |
| 70 | −0.28790 | 0.60574 | 1.46034 | 1.95721 | 2.15617 | 2.16081 | 2.05831 |
| 90 | −0.33672 | 0.40309 | 1.23678 | 1.91771 | 2.42343 | 2.76121 | 2.95613 |
| 110 | −0.36911 | 0.25303 | 0.99388 | 1.66858 | 2.25767 | 2.75067 | 3.14552 |
| 130 | −0.39210 | 0.14232 | 0.79333 | 1.41309 | 1.99034 | 2.51643 | 2.98561 |
| 150 | −0.40925 | 0.05835 | 0.63412 | 1.19379 | 1.73106 | 2.24048 | 2.71758 |
| 170 | −0.42253 | −0.00720 | 0.50710 | 1.01245 | 1.50525 | 1.98218 | 2.44029 |
| 190 | −0.43311 | −0.05968 | 0.40422 | 0.86284 | 1.31401 | 1.75570 | 2.18601 |
| 210 | −0.44174 | −0.10260 | 0.31953 | 0.73836 | 1.15257 | 1.56086 | 1.96199 |

TABLE 23
Cylindrical Body Diameter 10 Inch
L = 2 m
ηₐₗₗ for 10 Inch Diameter and L = 2 m

| | J(rate to J0) | | | | | | |
|---|---|---|---|---|---|---|---|
| di | 0.1 | 0.5 | 1 | 1.5 | 2 | 2.5 | 3 |
| 50 | −0.04843 | 1.07211 | 1.01769 | 0.64679 | 0.33887 | 0.11310 | −0.05301 |
| 70 | −0.16482 | 1.06682 | 1.84005 | 1.94703 | 1.76471 | 1.50512 | 1.24959 |
| 90 | −0.23790 | 0.84534 | 1.88482 | 2.49230 | 2.73935 | 2.75121 | 2.63321 |
| 110 | −0.28686 | 0.64338 | 1.67116 | 2.47661 | 3.03771 | 3.37738 | 3.54039 |
| 130 | −0.32176 | 0.48435 | 1.42828 | 2.25897 | 2.94823 | 3.48679 | 3.88077 |
| 150 | −0.34783 | 0.36045 | 1.21292 | 2.00497 | 2.71668 | 3.33527 | 3.85512 |
| 170 | −0.36804 | 0.26246 | 1.03228 | 1.76800 | 2.45689 | 3.08897 | 3.65734 |
| 190 | −0.38415 | 0.18346 | 0.88214 | 1.56053 | 2.21057 | 2.82533 | 3.39922 |
| 210 | −0.39729 | 0.11860 | 0.75672 | 1.38218 | 1.98982 | 2.57493 | 3.13342 |

For each curve in FIGS. 32 to 35, a ratio (di/L) between the inner diameter di and the length L of the hollow fiber forward osmosis membrane, which results in the maximum value of the overall efficiency ηₐₗₗ when the bundle of hollow fiber forward osmosis membranes is inserted in the inch diameter cylindrical body, is shown only with effective number in Table 24.

TABLE 24
Ratio between di and L (di/L) at Each Maximum Value for
10 Inch Diameter

| | J(rate to J0) | | | | | | |
|---|---|---|---|---|---|---|---|
| L | 0.1 | 0.5 | 1 | 1.5 | 2 | 2.5 | 3 |
| 0.5 | | | | | | | |
| 1 | | | | 56 | 71 | 75 | 78 |
| 1.5 | | | 46 | 51.3333 | 61.3333 | 66 | 72 |
| 2 | | 25 | 40.5 | 48 | 56.5 | 63 | 67 |

According to Tables 19 and 24, an equation that makes the optimal inner diameter (which results in the “maximum efficiency”) of the hollow fiber forward osmosis membrane converge to a constant value is expressed by [Equation 11]. Wherein the inner diameter changes from 50 μm and 200 μm, the length L of the hollow fiber forward osmosis membrane from 0.5 m to 2 m and the permeation flux rate J from J₀ to 2J₀ (J₀=1.713×10⁻⁷ m/s at 3 MPa).

The inner diameter d is measured in μm, and the length L is measured in m.
d=50 to 200 μm

### L=0.5 to 2 m

### J=1.7×10⁻⁷ to 5.1×10⁻⁷ m/s.

### [Equation 11]

$$\frac{d}{{L}^{0.75} \cdot {J}^{0.5}} = 1.0 \times {10}^{5} ∼ 1.2 \times {10}^{5}$$

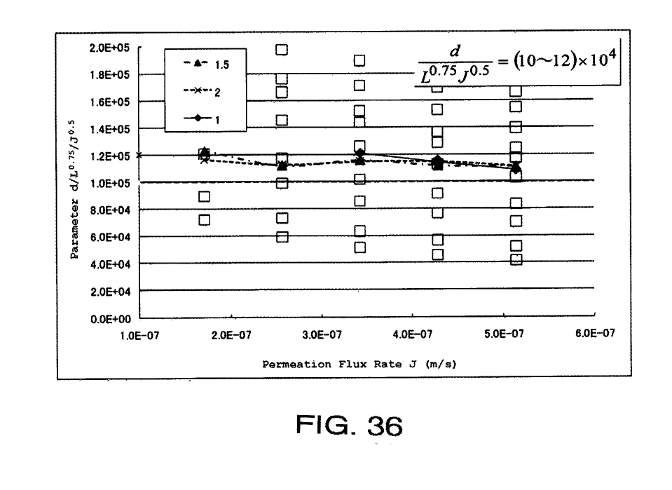

FIG. 36 shows the parameter d/(L^{0.75}·J^{0.5}) when the length L in [Equation 11] is specified in the range of L=0.5 to 2 m, similar to the specified range, it is evident that the parameter falls within the range.

What is claimed is:

1. A hollow fiber forward osmosis membrane, wherein
a relationship between optimal conditions for an inner diameter d and a length L of the hollow fiber forward osmosis membrane to be used for forward osmotic pressure power generation whereby dilution water such as fresh water or seawater having a less saline concentration than concentrate seawater is caused to permeate into the concentrate seawater through the hollow fiber forward osmosis membrane to increase a flow rate on the side of the concentrate seawater using forward osmotic pressure energy thus generated, and electric power is generated using the increased flow rate, is expressed as [Equation (1)] in the range of d=50 to 200 μm, L=0.5 to 2 m and J=3.42×10⁻⁷ to 6.84×10⁻⁷ m/sec,
[Equation 1]
$$\frac{d}{{L}^{0.75} \cdot {J}^{0.5}} = 1.9 \times {10}^{5} ∼ 2.2 \times {10}^{5}$$
wherein
J means permeation flux rate.

2. A hollow fiber forward osmosis membrane, wherein
the relationship between optimal conditions for an inner diameter d and a length L of the hollow fiber osmosis membrane to be used for forward osmotic pressure power generation whereby dilution water such as fresh water is caused to permeate into non-concentrate seawater through the hollow fiber osmosis membrane to increase a flow rate on the side of the seawater using forward osmotic pressure energy thus generated, and power is generated using the increased flow rate, is expressed as [Equation (11)] in the range of d=50 to 200 μm, L=0.5 to 2 m and J=1.7×10⁻⁷ to 5.1×10⁻⁷ m/sec,
[Equation 11]
$$\frac{d}{{L}^{0.75} \cdot {J}^{0.5}} = 1.0 \times {10}^{5} ∼ 1.2 \times {10}^{5}$$
wherein
J means permeation flux rate.
